(19) United States
(12) Patent Application Publication
(10) Pub. No.: US 2016/0029041 A1
(43) Pub. Date: Jan. 28, 2016

(54) IMAGE CODING METHOD, IMAGE CODING APPARATUS, IMAGE DECODING METHOD, IMAGE DECODING APPARATUS, AND STORAGE MEDIUM

(71) Applicant: CANON KABUSHIKI KAISHA, Tokyo (JP)

(72) Inventors: Mitsuru Maeda, Tokyo (JP); Satoshi Naito, Yokohama-shi (JP)

(21) Appl. No.: 14/876,434

(22) Filed: Oct. 6, 2015

Related U.S. Application Data
(63) Continuation of application No. 13/670,281, filed on Nov. 6, 2012.

(30) Foreign Application Priority Data
Nov. 8, 2011 (JP) 2011-244174

(51) Int. Cl. H04N 19/52; H04N 19/65; H04N 19/44; H04N 19/176

(52) U.S. Cl. CPC H04N 19/52; H04N 19/176; H04N 19/65; H04N 19/44

(57) ABSTRACT

An image coding method for an image coding apparatus includes determining an anchor picture in a same view as a picture to be coded, determining an anchor block corresponding to a block to be coded, selecting an inter-view prediction method, encoding an inter-view prediction mode indicating the inter-view prediction method, and calculating, using a parallax vector of the anchor block, a parallax vector of the block to be coded.

### CROSS REFERENCE TO RELATED APPLICATIONS

This application is a continuation of prior U.S. patent application Ser. No. 13/670,281, filed Nov. 6, 2012 which claims the benefit of Japanese Patent Application No. 2011-244174 filed Nov. 8, 2011. U.S. patent application Ser. No. 13/670,281 and Japanese Patent Application No. 2011-244174 are hereby incorporated by reference herein in their entirety.

### BACKGROUND OF THE INVENTION

1. Field of the Invention

The present invention relates to an image coding apparatus, an image coding method, an image decoding apparatus, an image decoding method, and a storage medium for performing image coding and decoding using a motion vector. In particular, the present invention relates to a motion-compensated image coding and decoding method employing a direct mode.

2. Description of the Related Art

H.264/Motion Picture Experts Group (MPEG)-4 Advanced Video Coding (AVC) (hereinafter referred to as H.264) is a compression recording method for a moving image (refer to International Organization for Standardization (ISO)/International Electrotechnical Commission (IEC) 14496-10: 2010 Information technology—Coding of audio-visual objects—Part 10: Advanced Video Coding).

H.264 is capable of performing temporal direct prediction in motion compensation, i.e., performing prediction from a coded block and generating a motion vector. More specifically, in the temporal direct prediction coding method, a block to be coded is encoded by referring to the motion vector of an anchor block. The anchor block is a block, in a reference picture having the smallest reference number (referred to as an anchor picture) in L1 prediction, at the same position as the block to be coded. Motion information of the anchor block is then proportionally-distributed from the position of the picture which includes the block to be coded, with respect to an interval between the anchor picture and a frame which the anchor block is to refer to. The motion vector is thus predicted and generated. As a result, motion compensation can be performed without transmission of coded information of the motion vector, so that coding efficiency is improved.

On the other hand, H.264 employs a multi-view video coding (MVC) method which encodes multi-view video images. The MVC method encodes a plurality of video images input from a plurality of cameras, by the images referring to each other and performing prediction. Hereinafter, each of the video images will be referred to as a view as in H.264 for ease of description. The MVC coding method uses correlativity between the views and performs prediction. Further, the MVC coding method performs prediction by calculating a parallax vector between the views, and encodes a prediction error. This is similar to calculating the motion vector in inter prediction, i.e., prediction performed in a temporal direction. Furthermore, the pictures in the views which have been recorded at the same time are collectively referred to as an access unit. Moreover, there always is a picture in the view which is encoded by only referring to the view. Such a view is referred to as a base view, and other views are referred to as non-base views.

In the H.264 MVC coding method, if a reference picture list RefPicList1 [0] points to a component in a different view, temporal direct prediction cannot be performed. Further, the H.264 MVC coding method does not perform the direct mode between the views using correlation between the views. In contrast, Japanese Patent Application Laid-Open No. 2008-509592 discusses performing direct prediction between the views. More specifically, the anchor picture is set in the same view, and the motion vector pointing to a different view in a different time referred to by the anchor block is proportionally-distributed based on time intervals and position information of the camera.

Further, activities have been started for internationally standardizing a successor coding method of H.264 having a higher efficiency. More specifically, Joint Collaboration Team on Video Coding (JCT-VC) has been established between ISO/IEC and International Telecommunication Union Telecommunication Standardization Sector (ITU-T). JCT-VC is developing High Efficiency Video Coding (HEVC) as a standard (refer to JCT-VC of ITU-T SG16 WP3 and ISO/IEC JTC1/SC29/WG11, JCTVC-A205, Test Model under Construction, Draft007, Jul. 18, 2010).

However, Japanese Patent Application Laid-Open No. 2008-509592 discusses internally-dividing a motion/parallax vector of the anchor block having two axes, i.e., temporal axis and spatial axis, by a distance on the temporal axis, and acquiring the vector for performing direct prediction. As a result, an inappropriate vector may be calculated. In particular, since the motion/parallax vector is internally-divided by the distance on the temporal axis, processing cannot be defined in the case where the vector of the anchor block does not include inter-view prediction.

### SUMMARY OF THE INVENTION

An example of the present invention is directed to performing, if the anchor picture is in the same view, prediction using the parallax vector of the anchor picture, so that inter-view prediction is performed without encoding the parallax vector of the block to be coded and thus improves the coding efficiency.

According to an aspect of the present invention, an image coding method for an image coding apparatus includes determining an anchor picture in a same view as a picture to be coded, determining an anchor block corresponding to a block to be coded, selecting an inter-view prediction method, encoding an inter-view prediction mode indicating the inter-view prediction method, and calculating, using a parallax vector of the anchor block, a parallax vector of the block to be coded.

According to an exemplary embodiment of the present invention, if an anchor picture is present in the same view, prediction is performed using a parallax vector of the anchor picture. As a result, inter-view prediction can be performed without coding a parallax vector of a block to be coded, so that the coding efficiency can be improved.

Further, according to an exemplary embodiment of the present invention, if an anchor picture is present in the same access unit, prediction is performed using a motion vector of the anchor picture. As a result, inter-picture prediction can be performed without coding a motion vector of a block to be coded, so that the coding efficiency can be improved.

Furthermore, according to an exemplary embodiment of the present invention, if an anchor picture is present in the same access unit, prediction is performed by calculating a parallax vector of a block to be coded using a parallax vector of the anchor picture. As a result, inter-view prediction can be performed without coding the parallax vector of the block to be coded, so that the coding efficiency can be improved.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute apart of the specification, illustrate exemplary embodiments, features, and aspects of the invention and, together with the description, serve to explain the principles of the invention.

FIG. 1 is a block diagram illustrating a configuration of an image coding system employing an image coding apparatus according to a first exemplary embodiment of the present invention.

FIG. 2 is a block diagram illustrating a configuration of a base view coding unit according to the first exemplary embodiment.

FIG. 3 is a block diagram illustrating a configuration of a non-base view coding unit according to first, second, and third exemplary embodiments of the present invention.

FIG. 4 is a block diagram illustrating an inter-view prediction unit according to the first exemplary embodiment.

FIG. 5 is a flowchart illustrating a base view coding process according to the first, second, and third exemplary embodiments.

FIG. 6 is a flowchart illustrating a non-base view coding process according to the first exemplary embodiment.

FIG. 7 is a flowchart illustrating an inter-view prediction coding process according to the first exemplary embodiment.

FIG. 8 illustrates processing of each view according to the first exemplary embodiment.

FIG. 9 illustrates another example of processing each view according to the first exemplary embodiment.

FIG. 10 is a flowchart illustrating another example of the inter-view prediction coding process according to the first exemplary embodiment.

FIG. 11 is a block diagram illustrating another example of the configuration of the image coding apparatus according to the first exemplary embodiment.

FIG. 12 is a block diagram illustrating a configuration of the non-base view coding unit according to the second exemplary embodiment.

FIG. 13 is a block diagram illustrating an inter-view prediction unit according to the second exemplary embodiment.

FIG. 14 is a flowchart illustrating an inter-view prediction coding process according to the second exemplary embodiment.

FIG. 15 illustrates processing of each view according to the second exemplary embodiment.

FIG. 16 is a block diagram illustrating a configuration of the non-base view coding unit according to the third exemplary embodiment.

FIG. 17 is a block diagram illustrating the inter-view prediction unit according to the third exemplary embodiment.

FIG. 18 is a flowchart illustrating the inter-view prediction coding process according to the third exemplary embodiment.

FIG. 19 illustrates processing of each view according to the third exemplary embodiment.

FIG. 20 is a block diagram illustrating a configuration of an image decoding system employing an image decoding apparatus according to an exemplary embodiment of the present invention.

FIG. 21 is a block diagram illustrating a configuration of a base view decoding unit according to fourth, fifth, and sixth exemplary embodiments of the present invention.

FIG. 22 is a block diagram illustrating a configuration of a non-base view decoding unit according to the fourth, fifth, and sixth exemplary embodiments.

FIG. 23 is a block diagram illustrating the inter-view prediction unit according to the fourth exemplary embodiment.

FIG. 24 is a flowchart illustrating the base view decoding process according to the fourth, fifth, and sixth exemplary embodiments.

FIG. 25 is a flowchart illustrating the non-base view decoding process according to the fourth, fifth, and sixth exemplary embodiments.

FIG. 26 is a flowchart illustrating the inter-view prediction decoding process according to the fourth embodiment.

FIG. 27 is a flowchart illustrating another example of the inter-view prediction decoding process according to the fourth embodiment.

FIG. 28 is a flowchart illustrating the inter-view prediction decoding process according to the fifth embodiment.

FIG. 29 is a block diagram illustrating the inter-view prediction unit according to the sixth exemplary embodiment.

FIG. 30 is a flowchart illustrating the inter-view prediction decoding process according to the sixth embodiment.

FIG. 31 is a block diagram illustrating a configuration example of hardware of a computer applicable to the image coding apparatus and the image decoding apparatus according to an exemplary embodiment of the present invention.

### DESCRIPTION OF THE EMBODIMENTS

Various exemplary embodiments, features, and aspects of the invention will be described in detail below with reference to the drawings.

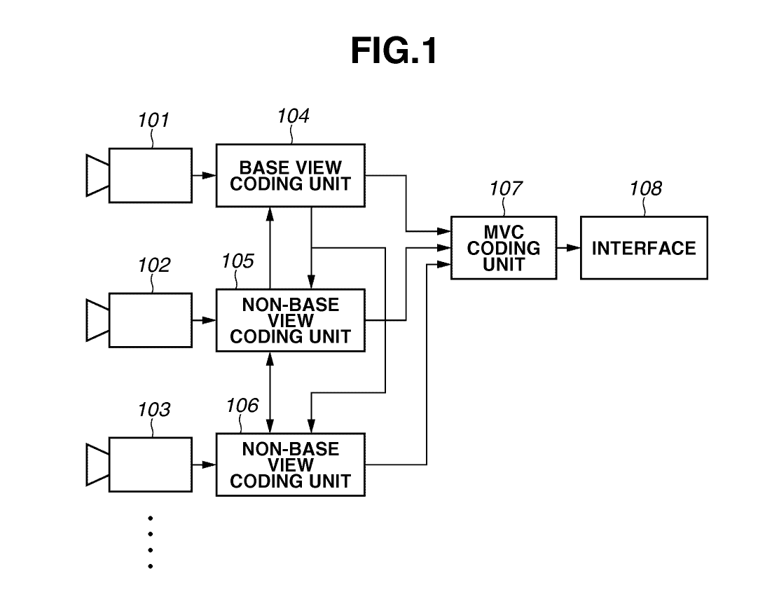

FIG. 1 is a block diagram illustrating a configuration of an image coding system employing an image coding apparatus according to a first exemplary embodiment of the present invention. Referring to FIG. 1, cameras 101, 102, and 103 capture respective pictures in synchronization with each other. There is no limit to the number of the cameras to be connected as long as there is a plurality of cameras. A base view coding unit 104 performs base view coding, and encodes the pictures captured by the camera 101. Non-base view coding units 105 and 106 perform non-base view coding, i.e., refer to other views and performs coding, on the pictures respectively captured by the cameras 102 and 103. An MVC coding unit 107 integrates the coded data which has been encoded for each view, and adds header data necessary in performing H.264 MVC coding. However, it is not limited thereto, and other multi-view coding methods may be used. An interface 108 outputs the generated bit stream to the outside.

As described above, in the image coding system, each coding unit encodes the image data of the view captured by each camera. The MVC coding unit 107 then generates the bit stream using the coded image data, and the interface 108 outputs the generated bit stream.

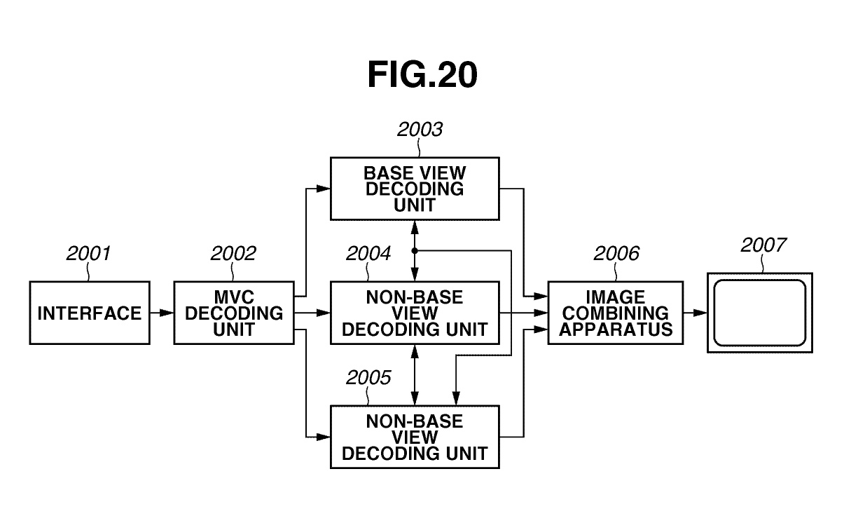

FIG. 20 is a block diagram illustrating an image decoding system employing an image decoding apparatus according to an exemplary embodiment of the present invention. Referring to FIG. 20, an interface 2001 inputs the bit stream of the image to be decoded. An MVC decoding unit 2002 decodes from the bit stream the coded data necessary for performing MVC coding, and separates and outputs the coded data of each view. A base view decoding unit 2003 decodes the base view. Non-base decoding units 2004 and 2005 refer to the other views and perform decoding. An image combining apparatus 2006 combines the image data of each view into the image data to be viewed by a user (not illustrated). A display 2007 is capable of performing stereoscopic display of the combined image.

As described above, in the image decoding system, the MVC decoding unit 2002 separates, into the coded data of each view, the bit stream input to the interface 2001. The base view decoding unit 2003 and the non-base decoding units 2004 and 2005 then decode the separated coded data and reproduce the image data of each view. The image combining apparatus 2006 combines the reproduced image data of each view to enable the user (not illustrated) to stereoscopically view the image data, and displays the image data on the display 2007.

According to the present exemplary embodiment, three views are encoded. However, the present invention is not limited thereto.

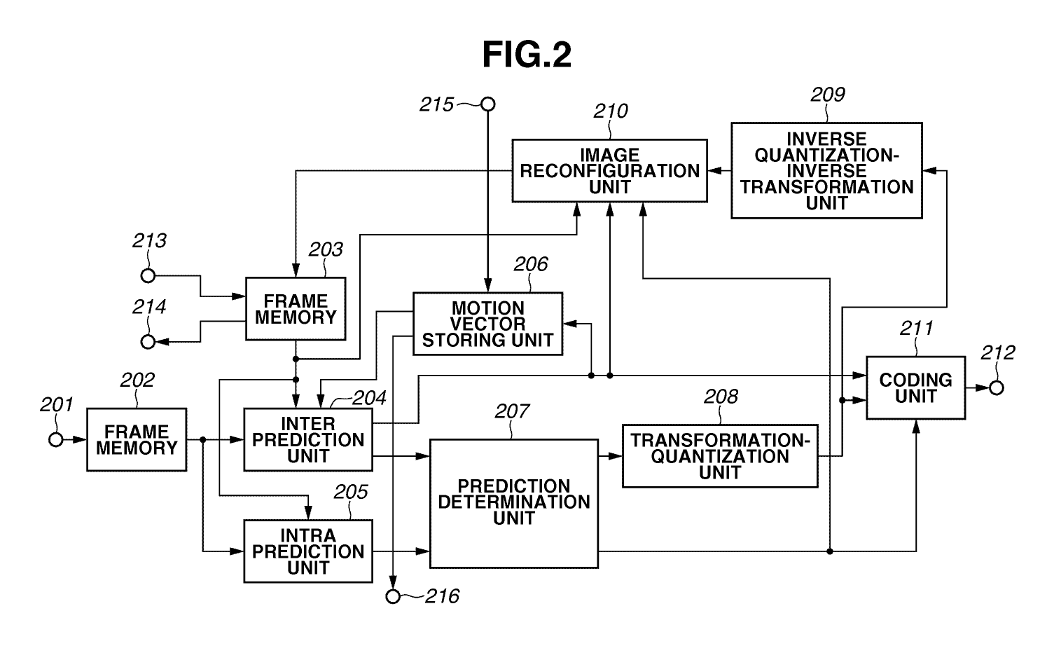

FIG. 2 is a block diagram illustrating in detail the base view coding unit 104 illustrated in FIG. 1. Referring to FIG. 2, a terminal 201 inputs the image data of the picture from the camera 101 illustrated in FIG. 1. A frame memory 202 stores the image data of one or more pictures. A frame memory 203 stores the reproduced image data. An inter prediction unit 204 refers to a previous or subsequent picture with respect to time, calculates the motion vector, and performs prediction based on the calculated motion vector. The inter prediction unit 204 also outputs a prediction error of the image data along with the motion vector. An intra prediction unit 205 performs prediction within the picture.

A motion vector storing unit 206 stores the motion vector calculated by the inter prediction unit 204 and a prediction mode. A prediction determination unit 207 compares the prediction error of the inter prediction unit 204 with the prediction error of the intra prediction unit 205, and selects the prediction whose prediction error is smaller. The prediction determination unit 207 then outputs the selected prediction error and the selection result.

A transformation-quantization unit 208 performs orthogonal transform on the prediction error, quantizes the result, and generates quantized coefficient data. An inverse quantization-inverse transformation unit 209 performs an inverse operation of the operation performed by the transformation-quantization unit 208, and reproduces the prediction error from the quantized coefficient data. An image reconfiguration unit 210 reproduces the image data from the prediction mode, the motion vector, the reproduced prediction error, and decoded image data. A coding unit 211 encodes the acquired prediction mode, motion vector, quantized coefficient data, and quantization parameters, and generates the coded data for each block.

A terminal 212 outputs the generated bit stream to the outside. A terminal 213 inputs, from the non-base view coding units 105 and 106, reference information stored in the frame memory 203. According to the present exemplary embodiment, the reference information is the information on the numbers of the view and the picture to be referred to, and a pixel position to be referred to. However, it is not limited thereto. The frame memory 203 thus includes a function for reading the image data designated by the reference information. A terminal 214 provides the image data of the decoded image of the view based on the reference information. A terminal 215 inputs the information on the position of the picture or the block from the non-base view coding units 105 and 106 illustrated in FIG. 1. A terminal 216 provides the motion vector of the block in the view based on the information input from the terminal 215.

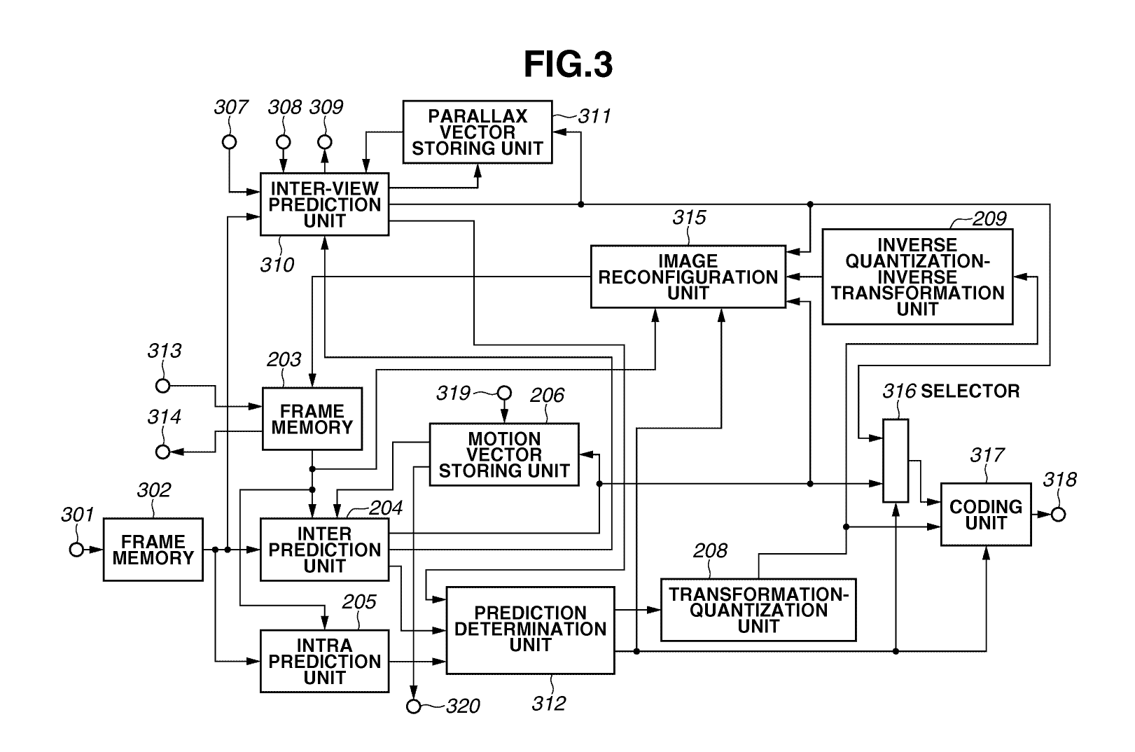

FIG. 3 is a block diagram illustrating in detail the non-base view coding unit 105 illustrated in FIG. 1, which is configured similarly as the non-base view coding unit 106. Blocks having similar functions as the blocks of the base view image coding unit 104 illustrated in FIG. 2 are assigned the same reference numbers, and description thereof will be omitted. Referring to FIG. 3, a terminal 301 inputs the image data of the picture received from the camera 102 or the camera 103. A frame memory 302 stores the image data of one or more pictures.

A terminal 307 inputs the reproduced image of the base view from the base view coding unit 104 and the reproduced image from the non-base view coding unit 106. A terminal 308 inputs the parallax vector from the view of a non-base view coding unit. According to the present exemplary embodiment, the terminal 308 inputs the parallax vector from the non-base view coding unit 106.

An inter-view prediction unit 310 performs inter-view prediction with respect to the picture input from terminals 301 and 307. More specifically, the inter-view prediction unit 310 refers to the other views and uses the parallax vectors of the other views to calculate the parallax vector, and performs inter-view prediction. The inter-view prediction unit 310 thus outputs the parallax vector, an inter-view prediction mode to be described below, and the prediction error of the image data. Further, the inter-view prediction unit 310 generates the reference information (i.e., the information on the numbers of the view and the picture to be referred to, and the pixel position to be referred to) for referring to the other views. A terminal 309 outputs the generated reference information to the base view coding unit 104 and the non-base view coding unit 106. A parallax vector storing unit 311 stores the parallax vectors calculated by the inter-view prediction unit 310.

A prediction determination unit 312 compares the prediction errors output from the inter prediction unit 204, the intra prediction unit 205, and the inter-view prediction unit 310, and selects the prediction having the smallest prediction error. The prediction determination unit 312 then outputs the selected prediction error and the selection result as the prediction mode. A terminal 313 inputs from the non-base view coding unit 106 illustrated in FIG. 1 the reference information to the frame memory 203. A terminal 314 provides the image data of the decoded image of the view based on the reference information.

An image reconfiguration unit 315 reproduces the image data from the prediction mode, the motion vector, the parallax vector, the reproduced prediction error, and the reproduced image data. A selector 316 outputs, by switching, the input according to the prediction mode generated by the prediction determination unit 312. A coding unit 317 encodes the acquired prediction mode, motion vector, parallax vector, inter-view prediction mode to be described below, and prediction error, and generates the coded data for each block.

A terminal 318 outputs the generated bit stream to the outside. A terminal 319 inputs from the non-base view coding unit 106 the information on the positions of the picture and the block. A terminal 320 provides the motion vector of the block in the view based on the information input from the terminal 319.

An image coding operation of the image coding apparatus will be described below. Since the non-base view coding units 105 and 106 perform the same operations with respect to the non-base view coding process, the process will be described as the operation performed by the non-base view coding unit 105.

In the base view image coding unit 104 illustrated in FIG. 2, the image data input from the terminal 201 of is input to and stored in the frame memory 202. At the same time, in the non-base view coding unit 105, the image data input from the terminal 301 illustrated in FIG. 3 is input to and stored in the frame memory 302. According to the present exemplary embodiment, the coding operation includes intra picture coding which encodes all blocks in the picture by performing intra picture prediction. Further, the coding operation includes inter picture coding which performs coding by referring to the previous and subsequent pictures with respect to time, and by performing motion compensation. However, it is not limited thereto, and the image coding apparatus may also perform bi-directional prediction. The frame memory 202 illustrated in FIG. 2 and the frame memory 302 illustrated in FIG. 3 store the necessary pictures.

Referring to FIG. 2, in the base view coding unit 104, the image data input from the terminal 201 is input to the inter prediction unit 204 and the intra prediction unit 205 via the frame memory 202. The inter prediction unit 204 then refers to the reproduced image data stored in the frame memory 203, performs motion compensation, and calculates the motion vector and the prediction error. The motion vector storing unit 206 stores the calculated motion vector and the prediction mode. Further, the intra prediction unit 205 refers to the reproduced image data stored in the frame memory 203, performs intra prediction, and then calculates an intra prediction mode and the prediction error. The prediction determination unit 207 compares the prediction errors calculated by the inter prediction unit 204 and the intra prediction unit 205, and selects the smaller prediction error.

If the prediction error input from the inter prediction unit 204 is smaller, the prediction determination unit 207 outputs the prediction error of the inter prediction unit 204 to the transformation-quantization unit 208. Further, the prediction determination unit 207 outputs, to the coding unit 211, information indicating that the mode is the inter prediction coding mode, and the motion vector. On the other hand, if the prediction error input from the intra prediction unit 205 is smaller, the prediction determination unit 207 outputs the prediction error of the intra prediction unit 205 to the transformation-quantization unit 208. Further, the prediction determination unit 207 outputs, to the coding unit 211, information indicating that the mode is the intra prediction coding mode, and the intra prediction mode.

The transformation-quantization unit 208 performs orthogonal transform on the input prediction error, quantizes the result using the quantization parameter, and calculates the quantized coefficient data. The transformation-quantization unit 208 then inputs the quantized coefficient data to the coding unit 211 and the inverse quantization-inverse transformation unit 209. The coding unit 211 encodes using the predetermined coding method the input coding mode, information on each prediction coding mode, quantization parameter, and quantized coefficient data. According to the present exemplary embodiment, there is no particular limit on the coding method, and coding such as H.264 arithmetic coding method and Huffman coding may be performed.

In contrast, the inverse quantization-inverse transformation unit 209 performs the opposite operation of the operation performed by the transformation-quantization unit 208 and calculates the prediction error. The image reconfiguration unit 210 receives the calculated prediction error and the prediction coding mode. If the mode is the inter prediction coding mode, the image reconfiguration unit 210 also receives the motion vector used in generating the prediction error. If the mode is the intra prediction coding mode, the image reconfiguration unit 210 also receives the intra prediction mode. The image reconfiguration unit 210 then performs prediction by referring to the reproduced image data stored in the frame memory 203 based on the information acquired from the prediction determination unit 207. The image reconfiguration unit 210 thus generates the reproduced image data by adding the prediction error to the prediction result, and stores the generated image data in the frame memory 203.

Further, referring to FIG. 3, in the non-base view coding unit 105, the image data input from the terminal 301 is input via the frame memory 302 to the inter prediction unit 204, the intra prediction unit 205, and the inter-view prediction unit 310. The inter-view prediction unit 310 refers to the reproduced image data of the base view stored in the frame memory 203 illustrated in FIG. 2, and the frame memory 203 in the non-base view coding unit 106, and calculates the parallax vector. The inter-view prediction unit 310 determines the inter-view prediction mode and the parallax vector to be actually employed, using the calculated parallax vector and the parallax vector in the parallax vector storing unit 311.

The inter-view prediction unit 310 then performs inter-view prediction using the determined parallax vector, and calculates the parallax vector and the prediction error. More specifically, the inter-view prediction unit 310 performs L1 prediction and sets as the anchor picture the reference picture having the smallest reference number in the same view. Further, the inter-view prediction unit 310 sets as the anchor block the block in the anchor picture which is at the same position as the block to be coded. The inter-view prediction unit 310 then determines whether the anchor block is performing inter-view prediction using the parallax vector thereof. If the anchor block has the parallax vector, the inter-view prediction unit 310 sets the parallax vector of the anchor block as the parallax vector of the block to be coded. The above-described inter-view prediction mode will be referred to as an inter-view direct prediction mode.

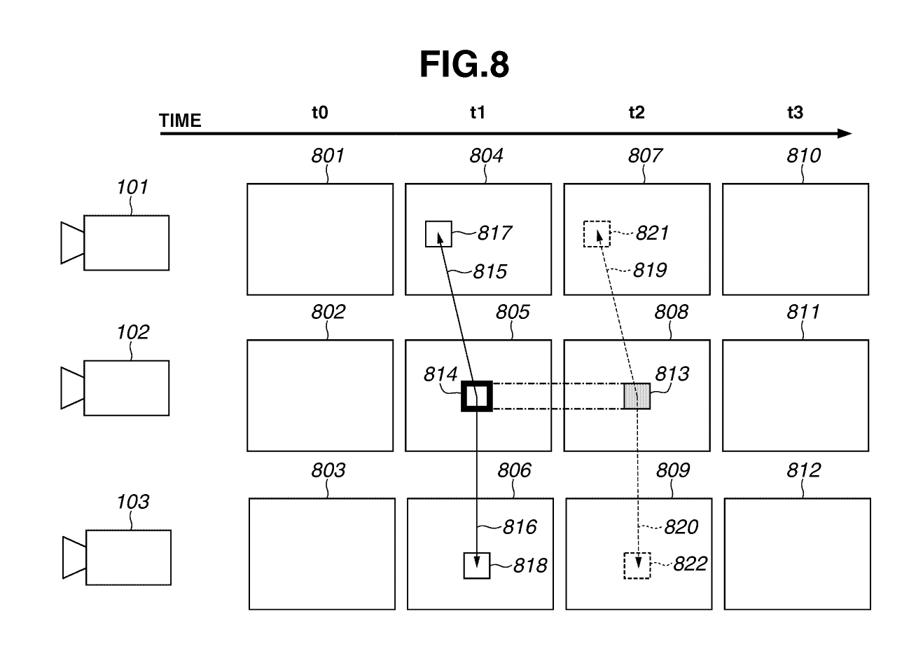

FIG. 8 illustrates the parallax vector in the inter-view direct prediction mode. Referring to FIG. 8, since the cameras 101, 102, and 103 have the same functions as the cameras 101, 102, and 103 illustrated in FIG. 1, description will be omitted.

The camera 101 sequentially inputs pictures 801, 804, 807, and 810 at time t0, time t1, time t2, and time t3, respectively. The camera 102 synchronously inputs pictures 802, 805, 808, and 811 in such order, and the camera 103 synchronously inputs pictures 803, 806, 809, and 812 in such order. A case where the input time of the picture having the smallest reference picture number in the L1 prediction is t1 when the input time of the picture to be coded is t2 will be described below. The number of cameras (i.e., number of views), the smallest reference picture number in the L1 prediction, and the time interval is not limited thereto.

The picture 805 is thus the anchor picture with respect to the picture to be coded 808. An anchor block 814 corresponds to a block to be coded 813. The anchor block 814 has parallax vectors 815 and 816, and refers to blocks 817 and 818 in the other views. In such a case, a parallax vector 819 of the block to be coded 813 is set to be equivalent to the parallax vector 815, and a parallax vector 820 to be equivalent to the parallax vector 816.

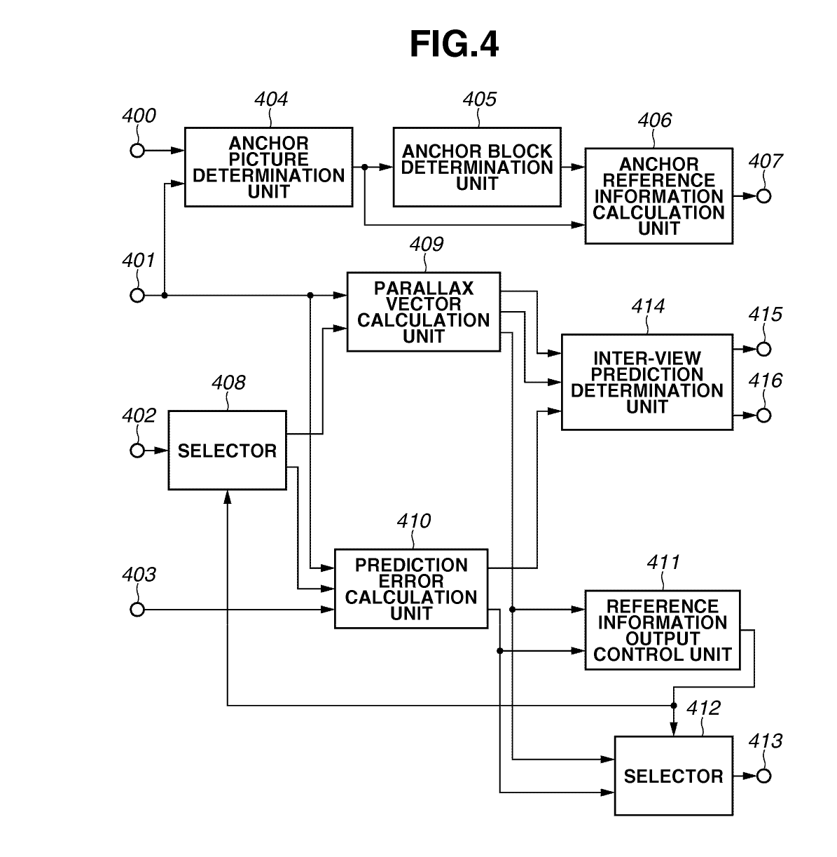

FIG. 4 is a block diagram illustrating in detail the inter-view prediction unit 310 in the non-base view coding unit 105 illustrated in FIG. 3. Referring to FIG. 4, a terminal 400 inputs from the inter prediction unit 204 illustrated in FIG. 3 the reference information of the picture for calculating the motion vector. The reference information of the picture is the information on the L1 prediction. A terminal 401 inputs from the frame memory 302 illustrated in FIG. 3 the image data of the block to be coded. A terminal 402 is connected to the terminal 308 illustrated in FIG. 3 and inputs the reference image data from the outside. A terminal 403 is connected to the parallax vector storing unit 311 and inputs the parallax vector.

An anchor picture determination unit 404 determines the anchor picture from the pictures in the same view. An anchor block determination unit 405 determines the position of the anchor block. An anchor reference information calculation unit 406 generates the reference information indicating the position of the anchor block in the anchor picture. A terminal 407 is connected to the parallax vector storing unit 311 and outputs the reference information indicating the position of the anchor block.

A selector 408 selects an output destination according to a control signal. A parallax vector calculation unit 409 calculates the parallax vector from the image data of the block to be coded and the image data of the view to be referred to. A prediction error calculation unit 410 calculates the prediction error from the image data of the reference view using the parallax vector input from the terminal 403. A reference information output control unit 411 controls output of the reference information to be used in reading the image data for the prediction error calculation unit 410 to refer to (i.e., an input to a selector 412). Further, the reference information output control unit 411 controls an input to the selector 408.

The selector 412 selects the input according to the signal from the reference information output control unit 411. A terminal 413 is connected to the terminal 309 illustrated in FIG. 3, and outputs, to the outside, the reference information for referring to the image data of the other views. An inter-view prediction determination unit 414 determines the inter-view prediction mode using the input prediction error, and selects and outputs the parallax vector and the prediction error. A terminal 415 outputs the information on the inter-view prediction mode and the parallax vector to the outside. A terminal 416 outputs the prediction error to the outside.

In the inter-view prediction unit 310 illustrated in FIG. 4, the image data of the block to be coded is input to the anchor picture determination unit 404, the parallax vector calculation unit 409, and the prediction error calculation unit 410. The anchor picture determination unit 404 determines the anchor picture from the input information on the picture of the block to be coded and reference information for performing inter prediction. The anchor picture determination unit 405 then selects as the anchor picture the reference picture having the smallest reference number in the same view in the L1 prediction information input from the terminal 400. Further, the anchor block determination unit 405 determines the position of the anchor block from the position information of the block to be coded. The position information of the block at the same position as the block to be coded is calculated using the number count of blocks.

The anchor reference information calculation unit 406 calculates the reference information from the above-described information on the anchor picture and the anchor block, and outputs the calculated reference information from the terminal 407 to the parallax vector storing unit 311. Further, anchor reference information calculation unit 406 inputs from the terminal 403 the parallax vector of the block matching the calculated reference information. The anchor reference information calculation unit 406 thus generates, based on the input parallax vector, the reference information for inputting the image data indicated by the parallax vector. The anchor reference information calculation unit 406 then inputs the generated reference information to the reference information output control unit 411 and the selector 412.

The reference information output control unit 411 controls the selector 412 to output the reference information in the input order. The reference information is output from the terminal 413 via the selector 412, and input to other base view coding units or non-base view coding units via the terminal 309. The result thereof is input from the terminal 402, and then input to the prediction error calculation unit 410 via the selector 408 by control of the reference information output control unit 411. The prediction error calculation unit 410 calculates the prediction error from the difference between the image data of the block to be coded and the input reference image data. The prediction error calculation unit 410 inputs the calculated prediction error to the inter-view prediction determination unit 414.

The parallax vector calculation unit 409 generates the reference information for designating the image data to be referred to, for calculating the parallax vector from the input position of the block to be coded to the other views. The parallax vector calculation unit 409 then inputs the generated reference information to the reference information output control unit 411 and the selector 412.

The reference information output control unit 411 performs, if no other reference information is input, control to output the reference information from the terminal 413 via the selector 412. The reference information is then input to the other base view coding units and the non-base view coding units via the terminal 309 illustrated in FIG. 3. The result thereof is input from the terminal 402 to the parallax vector calculation unit 409 via the selector 408 by control of the reference information output control unit 411. The parallax vector calculation unit 409 compares the input result with the image data of the block to be coded, and calculates the parallax vector. The parallax vector calculation unit 409 then inputs to the inter-view prediction determination unit 414 the calculated parallax vector and the prediction error generated when using the calculated parallax vector.

The inter-view prediction determination unit 414 compares the input prediction errors. If the prediction error input from the parallax vector calculation unit 409 is smaller, the inter-view prediction determination unit 414 outputs from the terminal 416 the prediction error output from the parallax vector calculation unit 409. At the same time, the inter-view prediction determination unit 414 outputs, from the terminal 415 to the outside, the parallax vector and information indicating that the inter-view prediction mode is an inter-view reference prediction mode. As described above, the inter-view prediction mode is a mode for performing coding using the parallax vector.

On the other hand, if the prediction error input from the parallax vector calculation unit 409 is not smaller, the inter-view prediction determination unit 414 outputs from the terminal 416 the prediction error output from the prediction error calculation unit 410. At the same time, the inter-view prediction determination unit 414 outputs, from the terminal 415 to the outside, information indicating that the inter-view prediction mode is an inter-view direct prediction mode.

The inter-view prediction mode and the parallax vector are then input to the selector 316 and the image reproduction unit 315, and the prediction error is input to the prediction determination unit 312, illustrated in FIG. 3. Further, the calculated parallax vector is input to and stored in the parallax vector storing unit 311.

The prediction determination unit 312 compares the prediction errors calculated in the inter prediction unit 204, the intra prediction unit 205, and the inter-view prediction unit 310, and selects the smallest prediction error. If the prediction error input from the inter prediction unit 204 is the smallest, the prediction determination unit 312 outputs the prediction error of the inter prediction unit 204 to the transformation-quantization unit 208. The prediction determination unit 312 also outputs, to the coding unit 317, information indicating that the mode is the inter prediction coding mode and the motion vector.

If the prediction error input from the intra prediction unit 205 is the smallest, the prediction determination unit 312 outputs the prediction error of the intra prediction unit 205 and the intra prediction mode to the transformation-quantization unit 208. The prediction determination unit 312 also outputs, to the coding unit 317, information indicating that the mode is the intra prediction coding mode, and the intra prediction coding mode.

If the prediction error input from the inter-view prediction unit 310 is the smallest, the prediction determination unit 312 outputs the prediction error of the inter-view prediction unit 310 to the transformation-quantization unit 208. The prediction determination unit 312 also outputs, to the coding unit 317, information indicating that the mode is the inter-view prediction coding mode.

Further, the selector 316 changes the input source according to the prediction mode for performing coding which is selected in the prediction determination unit 312. If the mode is the inter-view prediction coding mode, the selector 316 outputs the inter-view prediction coding mode and the parallax vector of the inter-view prediction unit 310 to the coding unit 317. If the mode is not the inter-view prediction coding mode, the selector 316 outputs the motion vector of the inter prediction unit 204.

The coding unit 317 encodes the input coding mode, the information on each prediction coding mode including the inter-view prediction mode, the quantization parameter, and the quantized coefficient data using a predetermined coding method.

According to the present exemplary embodiment, the coding method is not particularly limited, and coding such as H.264 arithmetic coding and Huffman coding can be performed. For example, direct_view_mv_pred_flag may be set subsequent to direct_spatial_mv_pred_flag, i.e., an H.264 spatial/temporal direct prediction determination flag. If the value of direct_view_mv_pred_flag is 0, it indicates the inter-view reference prediction mode, and if the value is 1, it indicates the inter-view direct prediction mode. Further, the mode may be indicated in 2 bits such as direct_mv_pred_mode. If the code is 0, the code indicates a spatial direct prediction mode, if 1, a temporal direct prediction mode, if 2, the inter-view direct prediction mode, and if 3, the inter-view reference prediction mode. If the inter-view prediction mode is the inter-view reference prediction mode, the parallax vector is also coded.

The inverse quantization-inverse transformation unit 210 reproduces the prediction error, and the image reconfiguration unit 315 receives the reproduced prediction error and the prediction coding mode. If the mode is the inter prediction coding mode, the motion vector used in generating the prediction error is also input to the image reconfiguration unit 315. Further, if the mode is the intra prediction coding mode, the intra prediction mode is also input to the image reconfiguration unit 315. Furthermore, if the mode is the inter-view prediction coding mode, the inter-view prediction mode and the parallax vector are also input to the image reconfiguration unit 315.

The image reconfiguration unit 315 then performs prediction by referring to the reproduced image data stored in the frame memory 203, based on the above-described information acquired from the prediction determination unit 312. The image reconfiguration unit 315 adds the prediction error to the prediction result and generates the reproduced image data. The reproduced image data is then stored in the frame memory 203 illustrated in FIG. 3.

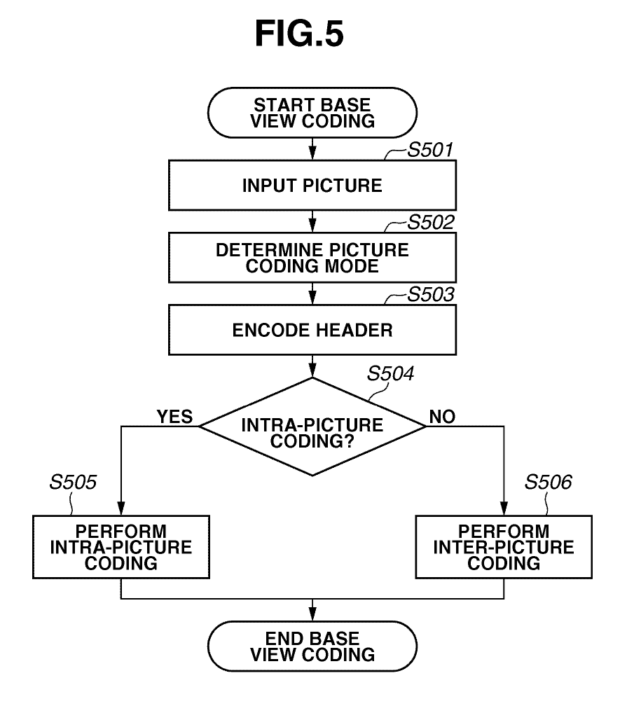

FIG. 5 is a flowchart illustrating the base-view image coding process performed in the image coding apparatus according to the first exemplary embodiment. In step S501, the image data of the picture to be coded is input to the image coding apparatus.

In step S502, the image coding apparatus determines the picture coding mode of the picture to be coded, i.e., determines whether to perform intra-picture coding, inter-picture coding, or inter-view prediction coding. In step S503, the image coding apparatus encodes the header data including the picture coding mode determined in step S502.

In step S504, the image coding apparatus determines whether intra picture coding is to be performed on the picture to be coded. If the picture coding mode is the intra-picture coding mode (YES in step S504), the process proceeds to step S505. If the picture coding mode is the inter-picture coding mode (NO in step S504), the process proceeds to step S506. In step S505, the image coding apparatus encodes the picture according to the H.264 intra-picture coding method and generates a bit stream. In step S506, the image coding apparatus encodes the picture according to the H.264 inter-picture coding method and generates a bit stream.

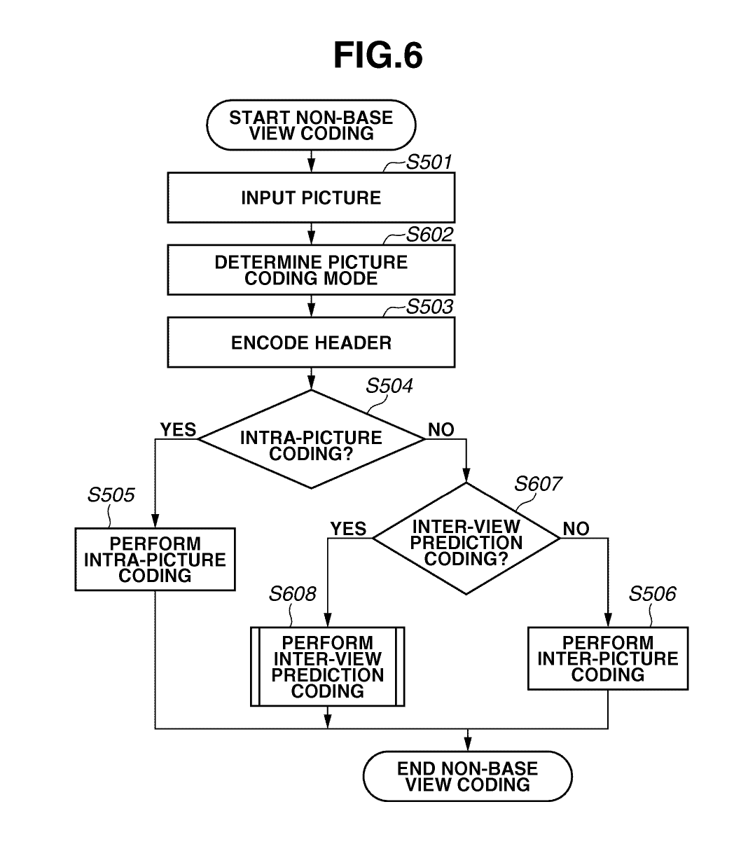

FIG. 6 is a flowchart illustrating the non-base view image coding process performed in the image coding apparatus according to the first exemplary embodiment. The steps illustrated in FIG. 6 performing the same functions as the steps illustrated in FIG. 5 are assigned the same step numbers, and description thereof will be omitted. In step S602, the image coding apparatus determines the picture coding mode of the picture to be coded, i.e., whether to perform intra-picture coding, inter-picture coding, or inter-view prediction coding.

In step S607, the image coding apparatus determines whether the picture coding mode for coding the picture is the inter-view prediction coding mode. If the picture coding mode is the inter-view prediction coding mode (YES in step S607), the process proceeds to step S608. If the picture coding mode is the inter-picture coding mode (NO in step S607), the process proceeds to step S506. In step S608, the image coding apparatus performs inter-view prediction coding and generates a bit stream.

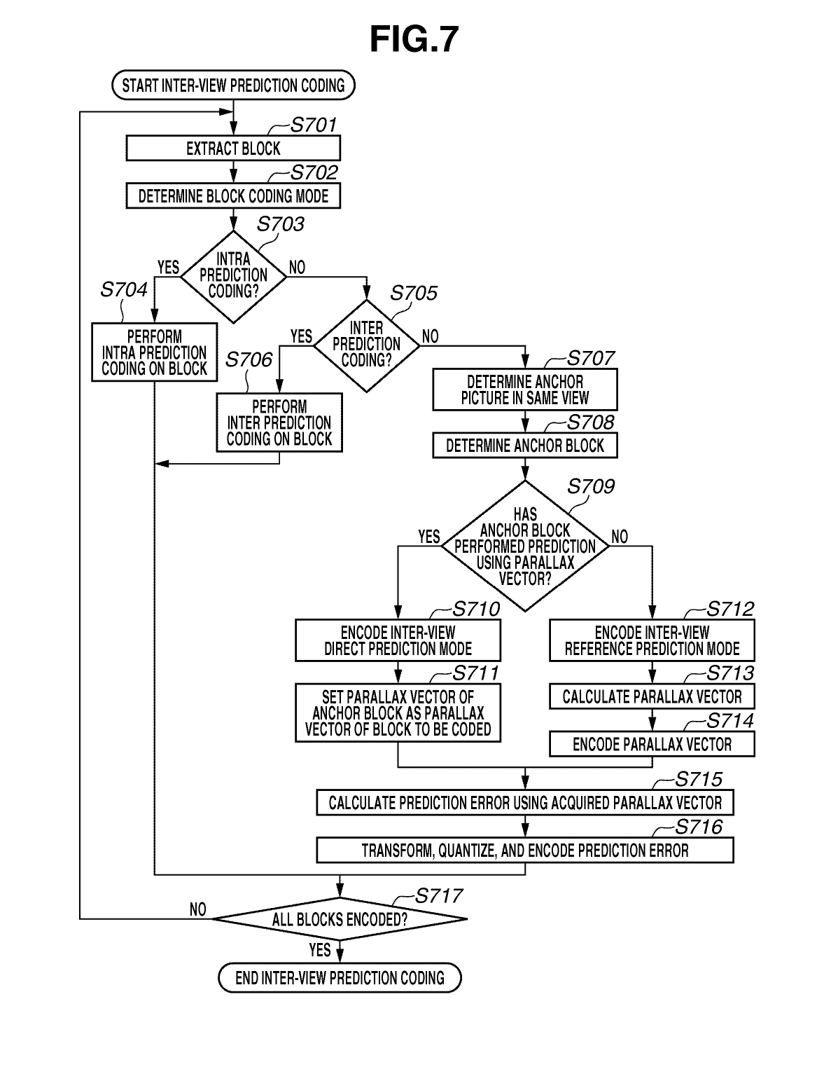

FIG. 7 is a flowchart illustrating in detail the process of step S608 (i.e., inter-view prediction coding) illustrated in FIG. 6. In step S701, the image coding apparatus extracts the block to be coded from the image data of the picture. In step S702, the image coding apparatus determines the coding mode of the block to be coded. According to the present exemplary embodiment, the method for determining the coding mode is not limited, and the coding mode can be determined based on characteristics of the image in the block and correlation with the surrounding blocks. In step S703, the image coding apparatus determines whether the coding mode of the block determined in step S702 is the intra prediction coding mode. If the coding mode is the intra prediction coding mode (YES in step S703), the process proceeds to step S704. On the other hand, if the coding mode is not the intra prediction coding mode (NO in step S703), the process proceeds to step S705.

In step S704, the image coding apparatus performs H.264 intra prediction block coding, and generates the coded data of the block. In step S705, the image coding apparatus determines whether the coding mode of the block determined in step S702 is the inter prediction coding mode. If the coding mode is the inter prediction coding mode (YES in step S704), the process proceeds to step S706. If the coding mode is not the inter prediction coding mode (NO in step S704), the process proceeds to step S707.

In step S706, the image coding apparatus performs H.264 inter prediction block coding, and generates the coded data of the block. In step S707, the image coding apparatus determines, as the anchor picture in the same view, the reference picture having the smallest reference number in the L1 prediction information. In step S708, the image coding apparatus sets, as the anchor block, the block which is at the same position as the block to be coded in the anchor picture determined in step S607 illustrated in FIG. 6.

In step S709, the image coding apparatus determines whether the anchor block has performed prediction using the parallax vector. If the anchor block has performed inter-view prediction coding using the parallax vector (YES in step S709), the process proceeds to step S710. If the anchor block has not performed inter-view prediction coding using the parallax vector (NO in step S709), the process proceeds to step S712. In step S710, the image coding apparatus sets the inter-view direct prediction mode as the coding mode of the block to be coded, and encodes the inter-view direct prediction mode. In step S711, the image coding apparatus sets the parallax vector of the anchor block as the parallax vector of the block to be coded.

In step S712, the image coding apparatus sets the inter-view reference prediction mode as the coding mode of the block to be coded, and encodes the inter-view reference prediction mode. In step S713, the image coding apparatus refers to the decoded image of a different view in the same access unit, and calculates the parallax vector. In step S714, the image coding apparatus encodes the calculated parallax vector.

In step S715, the image coding apparatus calculates the prediction error using the acquired parallax vector. In step S716, the image coding apparatus transforms and quantizes the calculated prediction error and calculates the quantized coefficient data, and encodes the quantized coefficient data. In step S717, the image coding apparatus determines whether all blocks in the picture have been encoded. If the image coding apparatus has not completed encoding all blocks (NO in step S717), the process returns to step S701, and the image coding apparatus continues to process the subsequent block to be coded. If all blocks have been encoded (YES in step S717), the process for coding the inter-view prediction coded picture ends.

As a result, when inter-view direct prediction is performed according to the above-described configuration and operation, the block to be coded is predicted using the parallax vector of the anchor block. The coded data of the parallax vector data thus becomes unnecessary.

According to the present exemplary embodiment, the H.264 coding method is employed. However, it is not limited thereto, and a coding method such as HEVC may also be used. Further, the coding methods of the moving vector and the parallax vector are not limited, and coding may also be performed by referring to the coded motion vector and parallax vector.

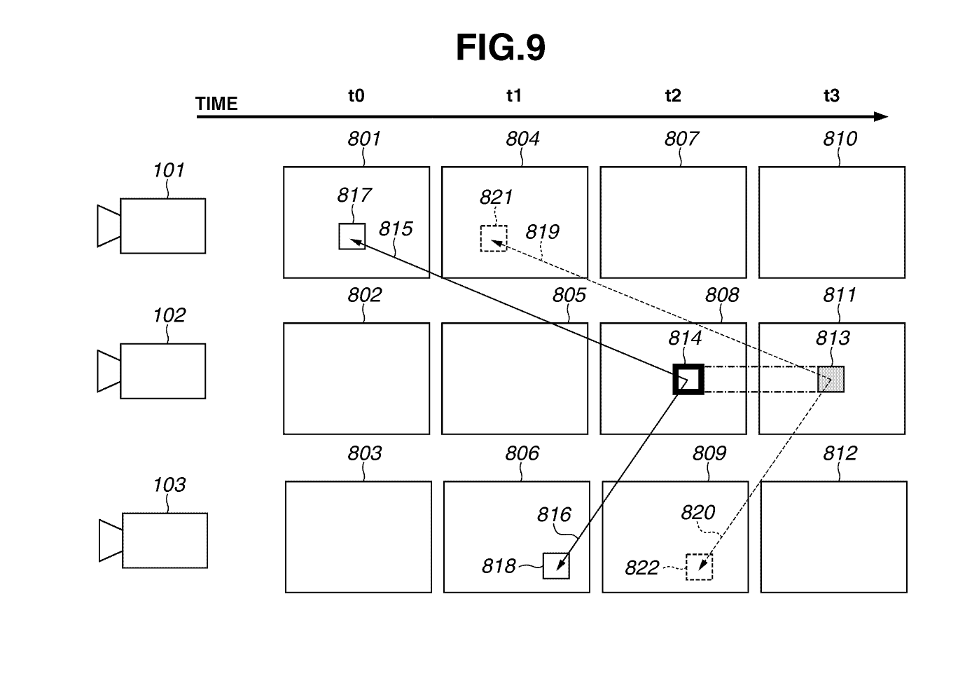

According to the present exemplary embodiment, the parallax vector with respect to the other views in the same access unit is described as illustrated in FIG. 8. However, it is not limited thereto. For example, referring to FIG. 9, other pictures in the other views may be referred to by a combination of the parallax vector and the reference picture thereof.

Further, according to the present exemplary embodiment, inter-view prediction using the parallax vector is performed in step S709 and thereafter. However, it is not limited thereto. For example, if the prediction mode of the anchor block is the temporal direct prediction mode, the block to be coded may also be coded by the temporal direct prediction mode.

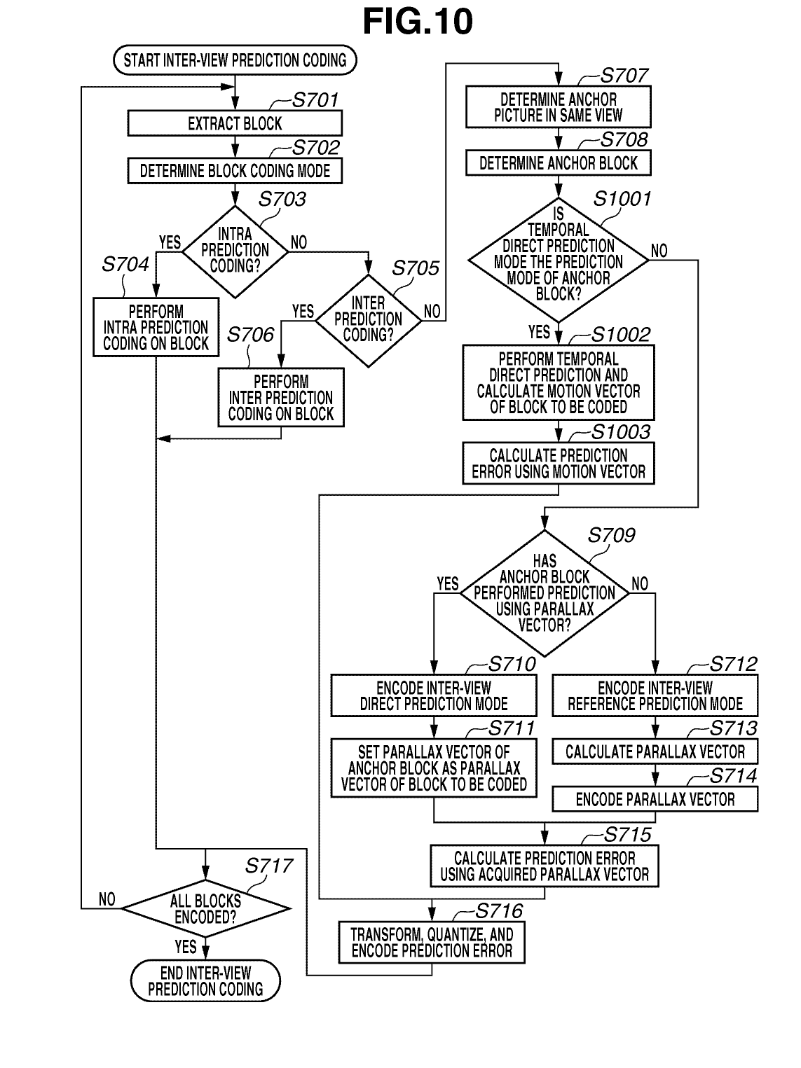

FIG. 10 is a flowchart illustrating another example of the inter-view picture coding process. The steps illustrated in FIG. 10 performing the same functions as the steps illustrated in FIG. 7 are assigned the same numbers, and description thereof will be omitted.

In step S1001, the image coding apparatus determines whether the prediction mode of the anchor block is the temporal direct prediction mode. If the prediction mode of the anchor block is the temporal direct prediction mode (YES in step S1001), the process proceeds to step S1002. In step S1002, the image coding apparatus calculates the motion vector of the block to be coded by performing temporal direct prediction. In step S1003, the image coding apparatus performs motion compensation using the calculated motion vector, and calculates the prediction error. If the prediction mode of the anchor block is not the temporal direct prediction mode (NO in step S1001), the process proceeds to step S709. In step S709, the image coding apparatus performs coding in the inter-view reference prediction mode or the inter-view direct prediction mode, similarly as in the flowchart illustrated in FIG. 7.

As a result, temporal direct prediction and inter-view direct prediction can be concurrently used, so that the coding efficiency can be further improved.

A configuration in which temporal direct prediction and inter-view direct prediction can be concurrently used will be described below with reference to FIG. 4. Referring to FIG. 4, the anchor reference information output from the anchor reference information calculation unit 406 is then output from the terminal 407. The anchor reference information is input to the motion vector storing unit 206 via the terminal 319 in the non-base view coding unit 105 illustrated in FIG. 3. The motion vector storing unit 206 is then referred to, and the result of whether temporal direct prediction has been performed is output from the terminal 320. The result is input to the terminal 403 illustrated in FIG. 4, and the prediction error calculation unit 410 outputs, to the inter-view prediction determination unit 414, information indicating that the prediction mode of the anchor block is the temporal direct prediction mode.

If the mode is the temporal direct prediction mode, the inter-view prediction determination unit 414 outputs, from the terminal 415, information indicating that the mode is the temporal direct prediction mode. Further, the inter-view prediction determination unit 414 does not output the prediction error and the parallax vector. Returning to FIG. 3, since the prediction error of performing inter-view prediction is not output, the prediction determination unit 312 does not select the inter-view prediction. The inter prediction unit 204 then reads from the motion vector storing unit 206 the prediction mode of the anchor block. If the read prediction mode is the temporal direct prediction mode, the inter prediction unit 204 performs motion compensation of the block to be coded in the temporal direct prediction mode.

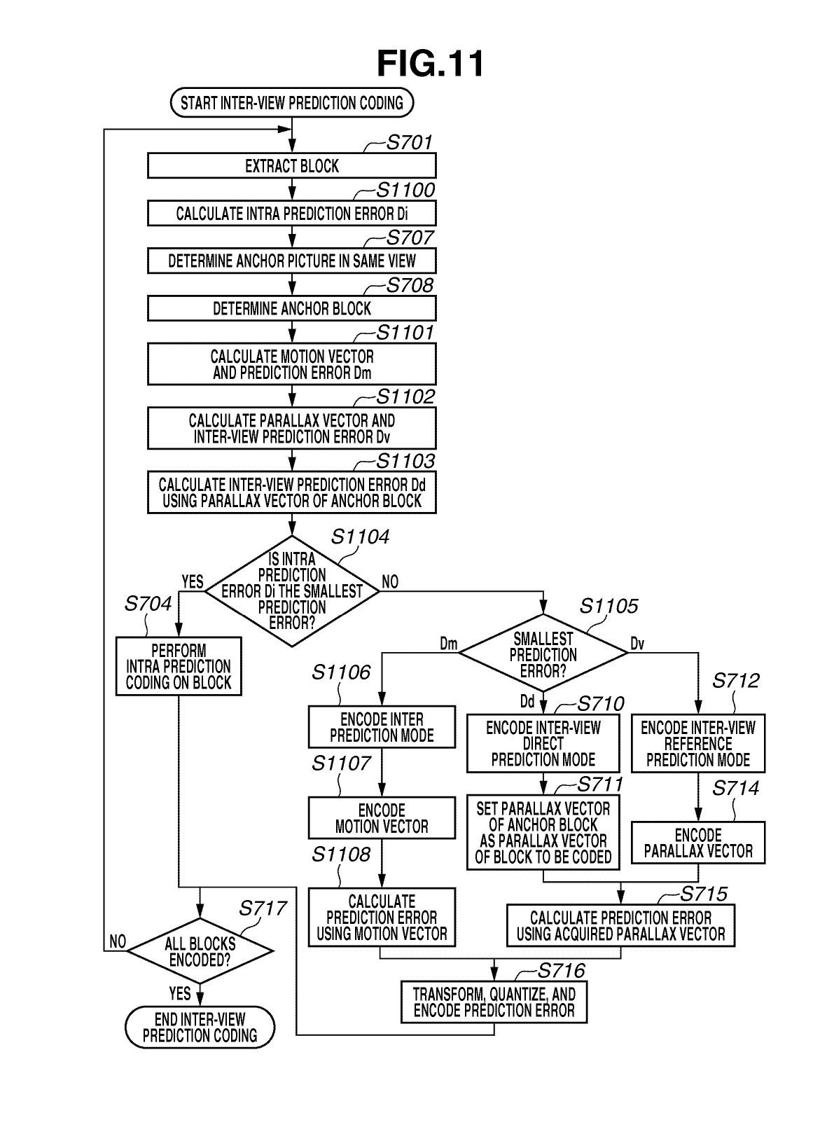

FIG. 11 is a flowchart illustrating another example of the inter-view picture coding process. The steps illustrated in FIG. 10 performing the same functions as the steps illustrated in FIG. 7 are assigned the same numbers, and description thereof will be omitted.

In step S1100, the image coding apparatus performs intra prediction of the block to be coded using pixel values of surrounding blocks, and calculates a prediction error Di.

In step S1101, the image coding apparatus refers to the other pictures in the view and calculates the motion vector. The image coding apparatus then performs inter prediction and acquires the prediction error, and calculates a prediction error cost Dm by performing square summation of the prediction error. In step S1102, the image coding apparatus refers to the pictures in the other views and calculates the parallax vector, performs inter-view prediction, acquires the prediction error, and calculates a prediction error cost Dv. In step S1103, the image coding apparatus performs inter-view prediction using the parallax vector of the anchor block, and calculates a prediction error cost Dd.

In step S1104, the image coding apparatus compares each of the prediction error costs with the prediction error Di. If the prediction error Di is the smallest (YES in step S1104), the process proceeds to step S704. If the prediction error Di is not the smallest (NO in step S1104), the process proceeds to step S1105.

In step S1105, the image coding apparatus compares the other prediction error costs, and if the prediction error cost Dm is the smallest (Dm in step S1105), the process proceeds to step S1106. If the prediction error cost Dv is the smallest (Dv in step S1105), the process proceeds to step S712. If the prediction error cost Dd is the smallest (Dd in step S1105), the process proceeds to step S710. In step S1106, the image coding apparatus encodes the inter prediction mode as the prediction mode. In step S1107, the image coding apparatus encodes the motion vector calculated in step S1101. In step S1108, the image coding apparatus performs motion compensation using the coded motion vector, and calculates the prediction error.

As a result, inter-picture prediction, inter-view reference prediction, and inter-view direct prediction can be concurrently performed, so that the coding efficiency can be further improved. The inter-picture prediction may include the temporal direct mode. Further, according to the present exemplary embodiment, the prediction error costs are calculated for determining the prediction mode. However, it is not limited thereto, and an actual code length or other statistical amounts may be used.

According to the present exemplary embodiment, when the image coding apparatus performs non-base view coding, the motion vector is not read from the view in the base-view coding. The terminals 215 and 216 may thus be omitted.

Further, according to the present exemplary embodiment, whether the coding mode is the intra prediction coding mode, the inter prediction coding mode, or the inter-view prediction mode is determined for each picture, for ease of description. However, it is not limited thereto, and the mode may be switched in a smaller unit, such as a slice or a block.

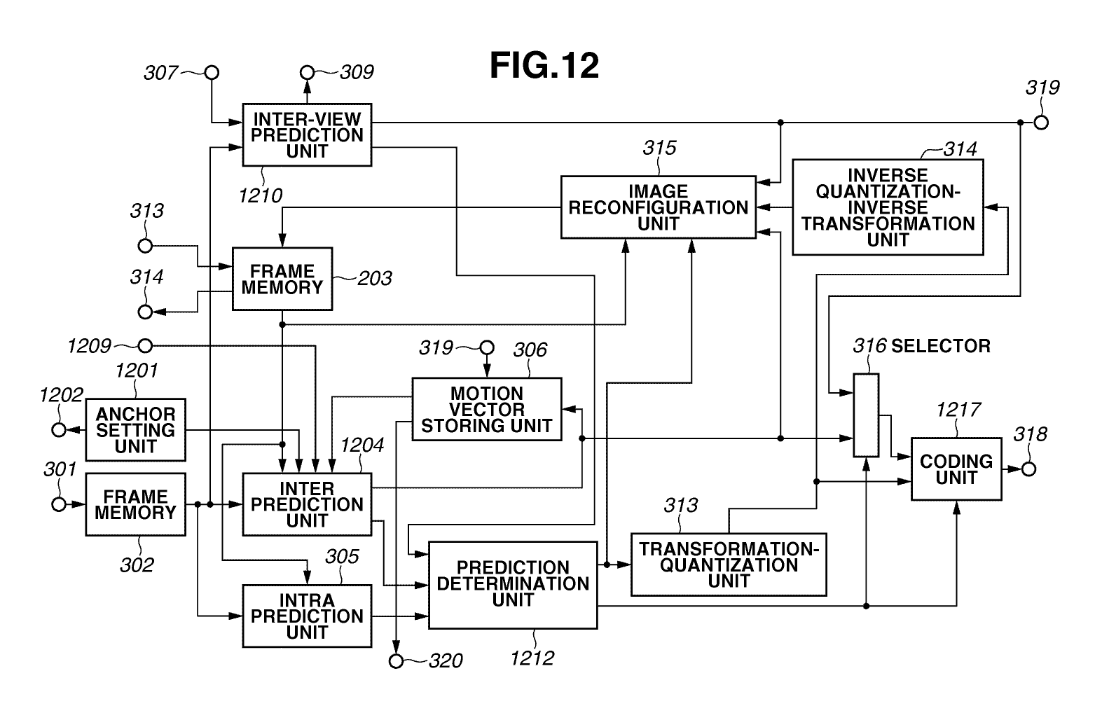

A process for encoding three views according to a second exemplary embodiment of the present invention will be described below. However, it is not limited thereto. FIG. 12 is a block diagram illustrating in detail the non-base view coding unit 105 illustrated in FIG. 2. The blocks illustrated in FIG. 12 performing the same functions as the blocks illustrated in FIG. 3 are assigned the same numbers, and description thereof will be omitted.

Referring to FIG. 12, an anchor setting unit 1201 determines and outputs the reference information of the anchor picture and the anchor block. A terminal 1202 is connected to the motion vector storing units with respect to the other views. In the non-base view coding unit 105, the reference information is input via the terminal 319, and the motion vector storing unit 306 outputs from the terminal 320 the motion vector of the block indicated by the reference information. The terminal 1202 outputs the reference information of the anchor block output from the anchor setting unit 1201. A terminal 1209 is connected to the terminal 216 of the base view coding unit 104 illustrated in FIG. 2 according to the first exemplary embodiment, and inputs the reference information of the view on which base view coding has been performed.

An inter prediction unit 1204 performs inter prediction based on the reference information input from the terminal 1209, which is different from the inter prediction unit 304 illustrated in FIG. 3 according to the first exemplary embodiment. An inter-view prediction unit 1210 determines the anchor block and calculates the reference information of the anchor block. The inter-view prediction unit 1210 then calculates, with respect to the picture input from the terminals 301 and 307, the parallax vector by referring to the other views, and performs inter-view prediction.

A coding unit 1217 encodes the acquired prediction mode, motion vector, parallax vector, prediction mode, and prediction error, and generates the coded data for each block, similarly as the coding unit 317 illustrated in FIG. 3 according to the first exemplary embodiment. A prediction determination unit 1212 compares the prediction errors acquired by the inter prediction unit 1204, the intra prediction unit 205, and the inter-view prediction unit 1210, and selects the prediction having the smallest prediction error. The prediction determination unit 1212 then outputs the selected prediction error and the selected result as the prediction mode.

The process for coding the image performed by the above-described image coding apparatus will be described below. The image data input from the terminal 301 is input via the frame memory 302 to the inter prediction unit 1204, the intra prediction unit 305, and the inter-view prediction unit 1210. The inter-view prediction unit 1210 then determines the parallax vector, performs inter-view prediction, and calculates the prediction error.

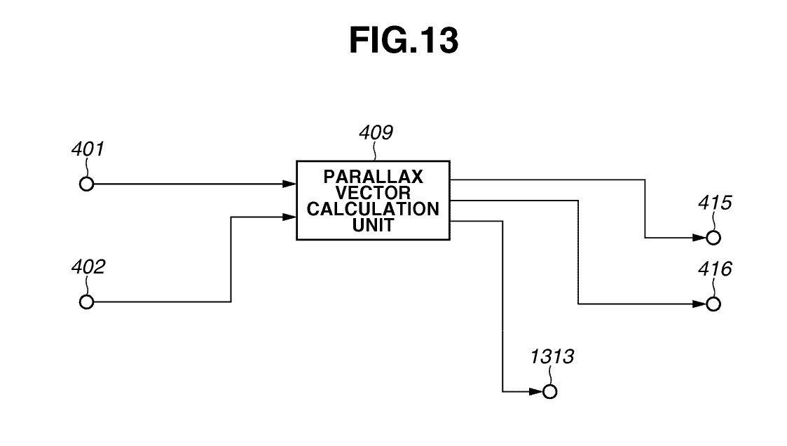

FIG. 13 is a block diagram illustrating in detail the inter-view prediction unit 1210. The blocks performing the same functions as the blocks in the inter-view prediction unit 310 illustrated in FIG. 4 are assigned the same reference numbers, and description thereof will be omitted. Referring to FIG. 13, a terminal 1313 outputs the reference information for designating the image data for the parallax vector calculation unit 409 to refer to the other views for calculating the parallax vector to be output.

The parallax vector calculation unit 409 generates the reference information for designating the image data to be referred to for calculating the parallax vector, similarly as in the first exemplary embodiment. The generated reference information is output from the terminal 1313. The reference information is then input via the terminal 309 to the other base view coding units and non-base view coding units. The result thereof is input from the terminal 402 to the parallax vector calculation unit 409. The parallax vector calculation unit 409 outputs the parallax vector and the prediction error which is generated when using the parallax vector, similarly as in the first exemplary embodiment. The terminal 416 then outputs, to the outside, the prediction error, and the terminal 415 outputs, to the outside, the parallax vector and information indicating that the inter-view prediction mode is the inter-view reference prediction mode.

Returning to FIG. 12, the anchor setting unit 1201 selects as the anchor picture the reference picture of the same access unit in the nearest view. The anchor setting unit 1201 then sets as the anchor block the block which is at the same position on the picture as the block to be coded, and outputs the reference information of the anchor block.

The inter prediction unit 1204 determines whether the anchor block set by the anchor setting unit 1201 is performing inter prediction using the motion vector. If the motion vector of the anchor block has been input from the terminal 1209, the inter prediction unit 1204 determines that inter prediction has been performed on the anchor block, and sets the motion vector of the anchor block as the motion vector of the block to be coded. In such a case, the inter prediction mode will be referred to as an inter-view temporal direct prediction mode. If the motion vector of the anchor block is not input from the terminal 1209, the inter prediction unit 1204 performs a normal motion vector search, and acquires the motion vector and the prediction error of the motion vector. In such a case, the inter prediction mode will be referred to as an inter motion compensation prediction mode.

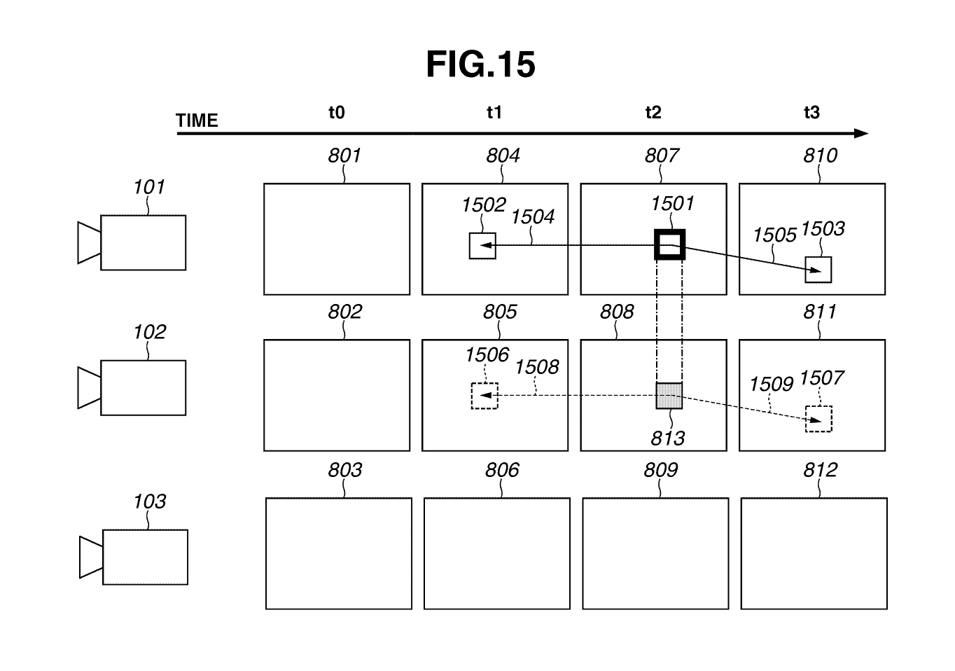

FIG. 15 illustrates the motion vector in the inter-view temporal direct prediction mode. The blocks illustrated in FIG. 15 performing the same functions as the blocks illustrated in FIG. 8 are assigned the same numbers, and description thereof will be omitted.

Referring to FIG. 15, the case where the view of the camera 101 has the nearest reference view number in inter-view prediction when the input time of the picture to be coded is t2 will be described below. However, the number of cameras (i.e., the number of views), the nearest reference number in inter-view prediction, and the time interval are not limited to the example illustrated in FIG. 15.

The anchor picture with respect to the picture to be coded 808 is the picture 807, and an anchor block 1501 corresponds to the block to be coded 813. The anchor block 1501 has the motion vectors 1504 and 1505, and refers to blocks 1502 and 1503 in the pictures of the same view. In such a case, a motion vector 1508 of the block to be coded 813 is set to be equivalent to the motion vector 1504, and a motion vector 1509 is set to be equivalent to the motion vector 1505.

The inter prediction unit 1204 illustrated in FIG. 12 thus inputs from the terminal 1209 the motion vector of the anchor block to realize the above-described setting, and calculates the prediction error using the input motion vector. Further, if the anchor block does not have the motion vector, the inter prediction unit 1204 refers to the reference image in the same view and searches for the motion vector. In such a case, inter prediction is performed.

The prediction determination unit 1212 then compares the prediction errors calculated by the inter prediction unit 1204, the intra prediction unit 205, and the inter-view prediction unit 1210, and selects the smallest prediction error. More specifically, if the prediction error acquired by the inter prediction unit 1204 in the inter-view temporal direct prediction mode or the inter prediction mode is small, the prediction determination unit 1212 outputs the prediction error of the inter prediction unit 1204 to the transformation-quantization unit 208. Further, the inter prediction unit 1204 outputs to the coding unit 1217 the inter-view temporal direct prediction mode or the inter prediction mode and the motion vector.

If the prediction error input from the intra prediction unit 205 is small, the prediction determination unit 1212 outputs to the transformation-quantization unit 208 the prediction error of the intra prediction unit 205 and the intra prediction mode. Further, the prediction determination unit 1212 outputs, to the coding unit 1217, information indicating that the mode is the intra prediction coding mode and the intra prediction mode.

If the prediction error input from the inter-view prediction unit 1210 is small, the prediction determination unit 1212 outputs to the transformation-quantization unit 208 the prediction error of the inter-view prediction unit 1210 and the prediction error. Further, the prediction determination unit 1212 outputs, to the coding unit 1217, information indicating that the mode is the inter-view prediction coding mode.

The selector 316 changes the input source according to the prediction mode selected by the prediction determination unit 1212. If the prediction determination unit 1212 has selected the inter-view prediction coding mode, the inter-view prediction coding mode and the parallax vector of the inter-view prediction unit 1210 is output to the coding unit 1217. If the prediction determination unit 1212 has not selected the inter-view prediction coding mode, the coding mode and the motion vector of the inter prediction unit 1204 are output.

The coding unit 1217 encodes, using the predetermined coding method, the input coding mode, information on each prediction coding mode including the inter-view prediction mode, quantization parameter, and quantized coefficient data. According to the present exemplary embodiment, the coding method is not particularly limited, and coding such as H.264 arithmetic coding and Huffman coding can be performed. For example, direct_view_mv_pred_flag may be set subsequent to direct_spatial_mv_pred_flag, i.e., the H.264 spatial/temporal direct prediction determination flag. If the value of direct_view_mv_pred_flag is 0, it indicates the inter-motion compensation prediction mode, and if the value is 1, it indicates the inter-view temporal direct prediction mode. Further, the mode may be indicated in 2 bits such as direct_mv_pred_mode. If the code is 0, the code indicates the spatial direct prediction mode, if 1, the temporal direct prediction mode, and if 2, the inter-view temporal direct prediction mode. If the inter-view prediction mode is the inter-view reference prediction mode, the parallax vector is also coded.

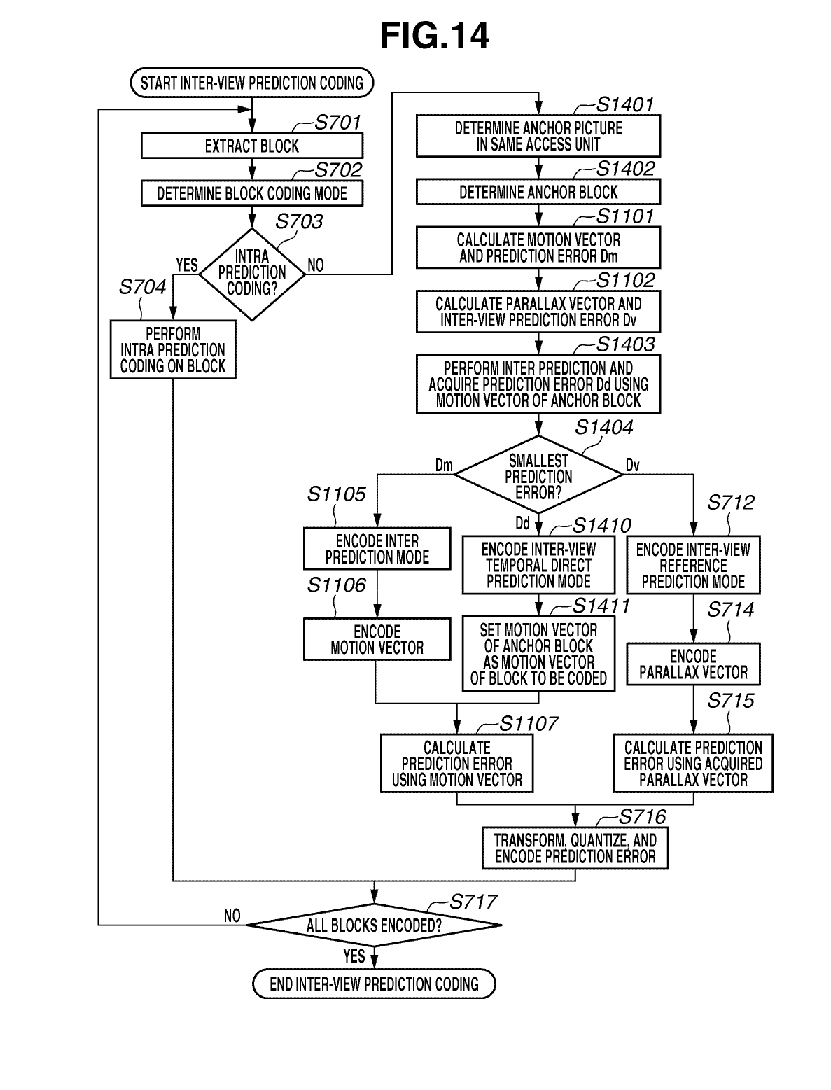

FIG. 14 is a flowchart illustrating the base view image coding process performed in the image coding apparatus according to the second exemplary embodiment. The steps illustrated in FIG. 14 performing the same functions as the steps illustrated in FIG. 10 are assigned the same numbers, and description thereof will be omitted.

In step S1401, the image coding apparatus determines, as the anchor picture of the same access unit, the view having the nearest number in inter-view prediction. In step S1402, the image coding apparatus sets as the anchor block the block in the determined anchor picture, which is at the same position as the block to be coded. In step S1403, the image coding apparatus performs inter prediction using the motion vector of the anchor block, acquires the prediction error, and calculates the prediction error cost Dd.

In step S1404, the image coding apparatus compares the prediction error costs. If the prediction error cost Dm is the smallest (Dm in step S1404), the process proceeds to step S1105. If the prediction error cost Dv is the smallest (Dv in step S1404), the process proceeds to step S712. If the prediction error cost Dd is the smallest (Dd in step S1404), the process proceeds to step S1410. In step S1410, the image coding apparatus encodes the inter-view temporal direct prediction mode as the prediction mode. In step S1411, the image coding apparatus sets the motion vector of the anchor block of the anchor block as the motion vector of the block to be coded.

As a result, when the inter-view temporal direct prediction is performed according to the above-described configuration and process, the block to be coded is predicted using the motion vector of the anchor block. The coded data of the motion vector data thus becomes unnecessary. Further, the coded data of the motion vector data becomes unnecessary in the temporal direct prediction mode of inter prediction.

According to the present exemplary embodiment, the H.264 coding method is employed. However, it is not limited thereto, and a coding method such as HEVC may also be used. Further, the coding methods of the moving vector and the parallax vector are not limited thereto, and coding may be performed by referring to the coded motion vector and parallax vector.

Furthermore, according to the present exemplary embodiment, inter-view temporal direct prediction may be combined with inter-view prediction, inter-view reference prediction, or inter prediction, and an efficient combination may be selected. Such a combination may be easily realized by preparing the coded data for identifying the type of prediction, and the coding efficiency may be further improved.

Moreover, according to the present exemplary embodiment, the position of the anchor block is at the same position as the block to be coded in the picture. However, it is not limited thereto, and the anchor block may be a block indicating a position which is spatially the same, based on an arrangement of the camera. Further, according to the present exemplary embodiment, the reference picture of the same access unit in the nearest view is set as the anchor picture. However, it is not limited thereto. For example, a reference direction may be uniquely determined, or identification information designating the anchor picture may be coded.

The process for encoding three views according to a third exemplary embodiment of the present invention will be described below. However, it is not limited thereto. According to the present exemplary embodiment, the configuration and the operations of the base view coding unit 104 are the same as those according to the first exemplary embodiment. The base view coding unit 104 thus encodes the picture input from the camera 101 without performing inter-view prediction.

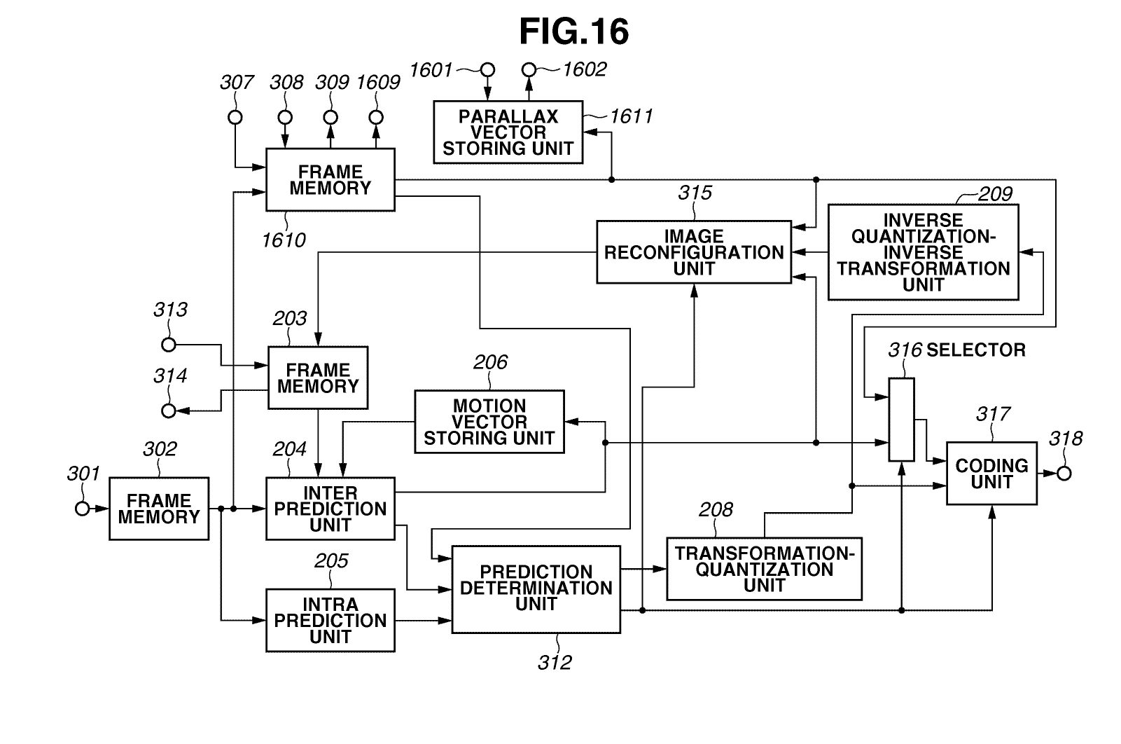

FIG. 16 is a block diagram illustrating in detail the non-base view coding unit 105 illustrated in FIG. 1. The blocks illustrated in FIG. 16 performing the same functions as the blocks in the non-base view coding units 105 and 106 illustrated in FIG. 3 are assigned the same numbers, and description thereof will be omitted.

Referring to FIG. 16, a terminal 1601 inputs from other non-base view coding units, i.e., the non-base view coding unit 106 according to the present exemplary embodiment, the information on the picture and the position of the block. A terminal 1602 outputs the parallax vector and the reference view number of the block in the view, based on the information input from the terminal 1601. A terminal 1609 outputs the reference information on the anchor block.

An inter-view prediction unit 1610 calculates from the parallax vector input from the terminal 1609, the parallax vector to be used in inter-view prediction, which is different from the inter-view prediction unit 310 illustrated in FIG. 3. A parallax vector storing unit 1611 stores the parallax vector and the reference view number which the parallax vector refers to. The parallax vector storing unit 1611 reads the information according to the request from the terminal 1601 and outputs the read information from the terminal 1602, which is different from the parallax vector storing unit 311 illustrated in FIG. 3. A coding unit 1617 encodes the acquired prediction mode, motion vector, parallax vector, inter-view prediction mode, and prediction error, and generates the coded data for each block.

The operation of the non-base view coding unit 105 will be described below with reference to FIG. 16. The image data received from the terminal 301 is input via the frame memory 302 to the inter prediction unit 204, the intra prediction unit 205, and the inter-view prediction unit 1610.

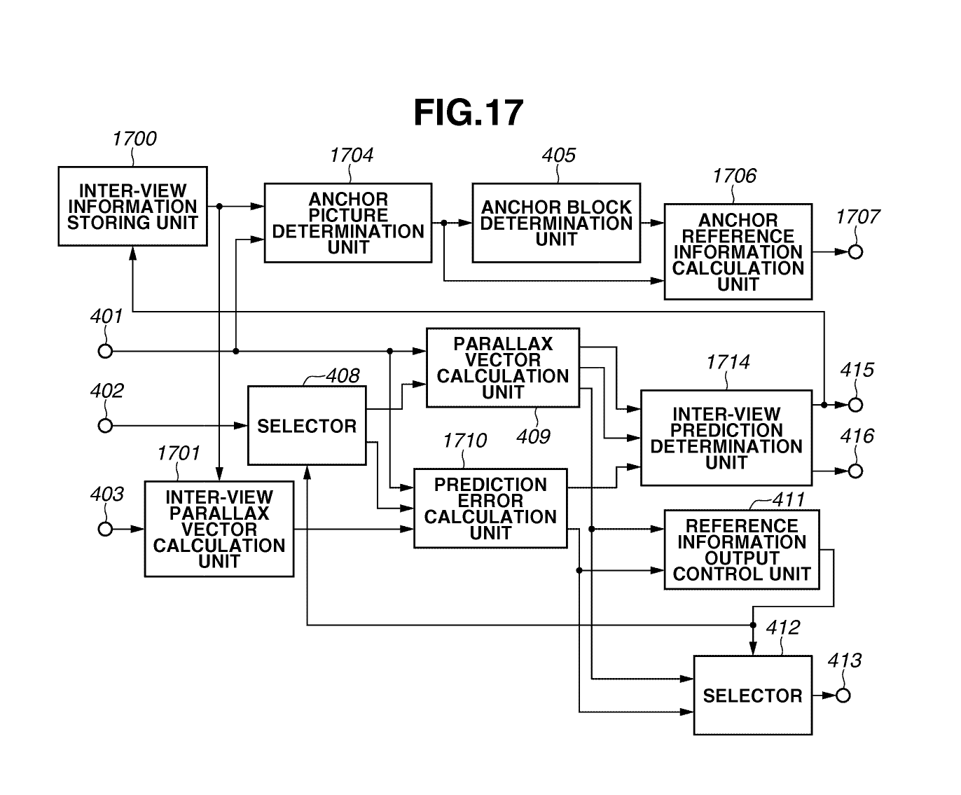

FIG. 17 is a block diagram illustrating in detail the inter-view prediction unit 1610. The blocks illustrated in FIG. 17 performing the same functions as the blocks illustrated in the inter-view prediction unit 310 illustrated in FIG. 4 are assigned the same reference numbers, and description thereof will be omitted.

Referring to FIG. 17, an inter-view information storing unit 1700 stores inter-view information including positional relation between the other views of the non-view coding unit 105. A parallax vector calculation unit 1701 calculates the parallax vector to be used in inter-view prediction from the parallax vector input from the terminal 403 and the information of the positional information in the inter-view information storing unit 1700.

An anchor picture determination unit 1704 determines the reference picture from the picture to be coded and the inter-view information. An anchor reference information calculation unit 1706 generates the reference information indicating the position of the anchor block in the anchor picture. A terminal 1707 is connected to the parallax vector storing units 311 and 1611 of the other views, and outputs the reference information indicating the position of the anchor block. A prediction error calculation unit 1710 calculates the prediction error from the image data of the reference view using the input parallax vector.

The parallax vector calculation unit 409 calculates the parallax vector using the reproduced image data of the base view of the base view coding unit 104 illustrated in FIG. 2 or the reproduced image data of the non-base view coding unit from the terminal 402 and the selector 408. This is similar to the first exemplary embodiment.

The anchor picture determination unit 1704 refers to the inter-view information storing unit 1700 and selects the non-base view having the nearest reference number in inter-view prediction. The anchor picture determination unit 1704 then selects as the anchor picture the picture in the same access unit of the selected view. The anchor block determination unit 1704 sets as the anchor block the block in the anchor picture which is at the same position as the block to be coded.

The anchor reference information calculation unit 1706 calculates, from the information on the anchor picture and the anchor block, the reference information. The anchor reference information calculation unit 1706 then outputs the calculated reference information from the terminal 1707 to the parallax vector storing unit 1611 in the non-base view coding unit of the other views. According to the present exemplary embodiment, the anchor reference information calculation unit 1706 outputs the calculated reference information to the non-base view coding unit 106.

Returning to FIG. 16, the parallax vector storing unit 1611 receives the reference information via the terminal 1601 and outputs the parallax vector from the terminal 1602. The parallax vector is then input from the terminal 403 illustrated in FIG. 17. The inter-view parallax vector calculation unit 1701 calculates the parallax vector to be used in inter-view prediction based on the input parallax vector and the inter-view information stored in the inter-view information storing unit 1700.

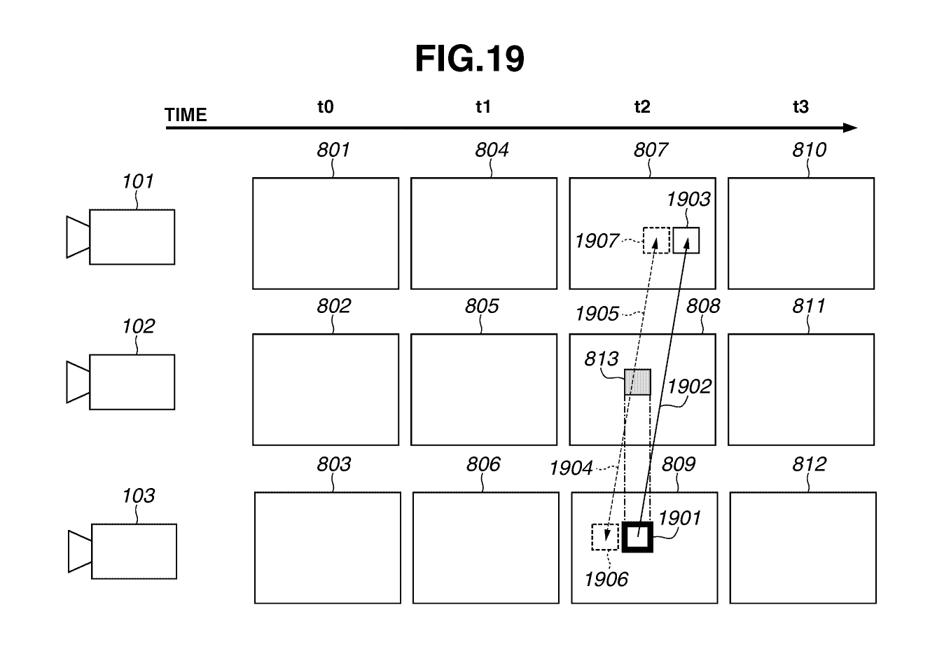

FIG. 19 illustrates the calculation of the parallax vector by the inter-view parallax vector calculation unit 1701. The blocks illustrated in FIG. 19 performing the same functions as the blocks illustrated in FIG. 8 are assigned the same numbers, and description thereof will be omitted.

Referring to FIG. 19, the case where the view input from the camera 103 has the nearest reference view number in inter-view prediction when the input time of the picture to be coded is t2 will be described below. However, the number of cameras (i.e., the number of views), the nearest reference number in inter-view prediction, and the time interval are not limited to the example illustrated in FIG. 19.

The anchor picture with respect to the picture to be coded 808 is the picture 809, and an anchor block 1901 corresponds to the block to be coded 813. The anchor block 1901 has a motion vector 1902. In such a case, the inter-view parallax vector calculation unit 1701 determines whether the view referred to by the parallax vector 1902 exists at a position opposite to the view including the anchor picture when viewed from the view to be coded.

If the parallax vector 1902 is referring to a block 1903 in the view at the opposite position, the inter-view parallax vector calculation unit 1701 selects the inter-view parallax direct prediction mode. In other words, the inter-view parallax vector calculation unit 1701 calculates the parallax vector of the block to be coded 813 using the parallax vector 1902. The block to be coded 813 thus refers to the view including the anchor picture and the view including the block which the anchor block refers to.

The inter-view parallax vector calculation unit 1701 then internally-divides the parallax vector 1902 based on the distances between the camera 101 and the camera 102 and between the camera 102 and the camera 103. For example, it is assumed that the components of the parallax vector 1902 are (x, y), and a ratio of the distance between the camera 101 and the camera 102 to the distance between the camera 102 and the camera 103 is α:β (α+β=1). In such a case, a parallax vector 1905 with respect to the view of the camera 101 becomes (αx, αy), and a parallax vector 1904 with respect to the view of the camera 103 becomes (−βx, −βy). The inter-view parallax vector calculation unit 1701 then acquires a block 1906 from the picture of the view of the camera 103 according to the parallax vector 1904, and a block 1907 from the picture of the view of the camera 101 according to the parallax vector 1905, and calculates the prediction block.

The above-described inter-view prediction mode in which prediction is performed by calculating the parallax vector of the block to be coded from the parallax vector of the anchor block will be referred to as an inter-view parallax direct prediction mode.

The prediction error calculation unit 1710 in the inter-view prediction unit 1610 illustrated in FIG. 17 calculates two pieces of reference information of the other views based on the internally-divided parallax vector, and outputs the result from the terminal 413 via the selector 412. In the example illustrated in FIG. 19, one of the pieces of reference information is for reading the reproduced image data of the corresponding position of the non-base view coding unit 106 based on the parallax vector 1904. More specifically, the reference information is input from the terminal 213 illustrated in FIG. 2, and the data of the block 1907 is read from the frame memory 203 and is then output from the terminal 213. The other reference information is for reading the reproduced image data of the corresponding position of the base view coding unit 104 based on the parallax vector 1905. More specifically, the reference information is input from the terminal 313 illustrated in FIG. 16, and the data of the block 1906 is read from the frame memory 203 and is then output from the terminal 314. The prediction error calculation unit 1710 thus calculates the prediction error from the blocks 1906 and 1907 and the block to be coded.

An inter-view prediction determination unit 1714 then determines, using the input prediction error, the inter-view prediction mode, and selects and outputs the parallax vector and the prediction error. If the prediction error input from the parallax vector calculation unit 409 is smaller, the inter-view prediction determination unit 1714 outputs from the terminal 416 the prediction error output from the parallax vector calculation unit 409. At the same time, the inter-view prediction determination unit 1714 outputs, from the terminal 415 to the outside, the parallax vector and information indicating that the inter-view prediction mode is the inter-view reference prediction mode.

On the other hand, if the prediction error input from the parallax vector calculation unit 409 is not smaller, the inter-view prediction determination unit 1714 outputs from the terminal 416 the prediction error output from the prediction error calculation unit 1710. At the same time, the inter-view prediction determination unit 1714 outputs, from the terminal 415 to the outside, information indicating that the inter-view prediction mode is the inter-view direct prediction mode.

Further, if the anchor block does not have the parallax vector, or the view indicated by the parallax vector is in the same direction when viewed from the view to be coded, the inter-view prediction determination unit 1714 selects the output from the parallax vector calculation unit 409. Furthermore, the inter-view prediction determination unit 1714 sets the inter-view prediction mode as the inter-view reference prediction mode.

Returning to FIG. 16, the inter-view prediction mode and the parallax vector are input to the selector 316 and the image reconfiguration unit 315. The prediction error is input to the prediction determination unit 312. The calculated parallax vector is input and stored in the parallax vector storing unit 1611.

The prediction determination unit 312 compares the prediction errors similarly as in the first exemplary embodiment and selects the smallest prediction error. Further, the selector 316 changes the input source similarly as in the first exemplary embodiment. The coding unit 1617 encodes the input coding mode, information on each prediction coding mode including the inter-view prediction mode, quantization parameter, and quantized coefficient data using a predetermined coding method.

According to the present exemplary embodiment, there is no particular limit on the coding method, and coding such as H.264 arithmetic coding and Huffman coding can be performed. For example, direct_view_mv_pred_flag may be set subsequent to direct_spatial_mv_pred_flag, i.e., a H.264 spatial/temporal direct prediction determination flag. If the value of direct_view_mv_pred_flag is 0, it indicates the inter-view reference prediction mode, and if the value is 1, it indicates the inter-view parallax direct prediction mode.

Further, the mode may be indicated in 2 bits such as direct_mv_pred_mode. If the code is 0, it indicates the spatial direct prediction mode, if 1, the temporal direct prediction mode, if 2, the inter-view parallax direct prediction mode, and if 3, the inter-view reference prediction mode. If the inter-view prediction mode is the inter-view reference prediction mode, the parallax vector is also coded.

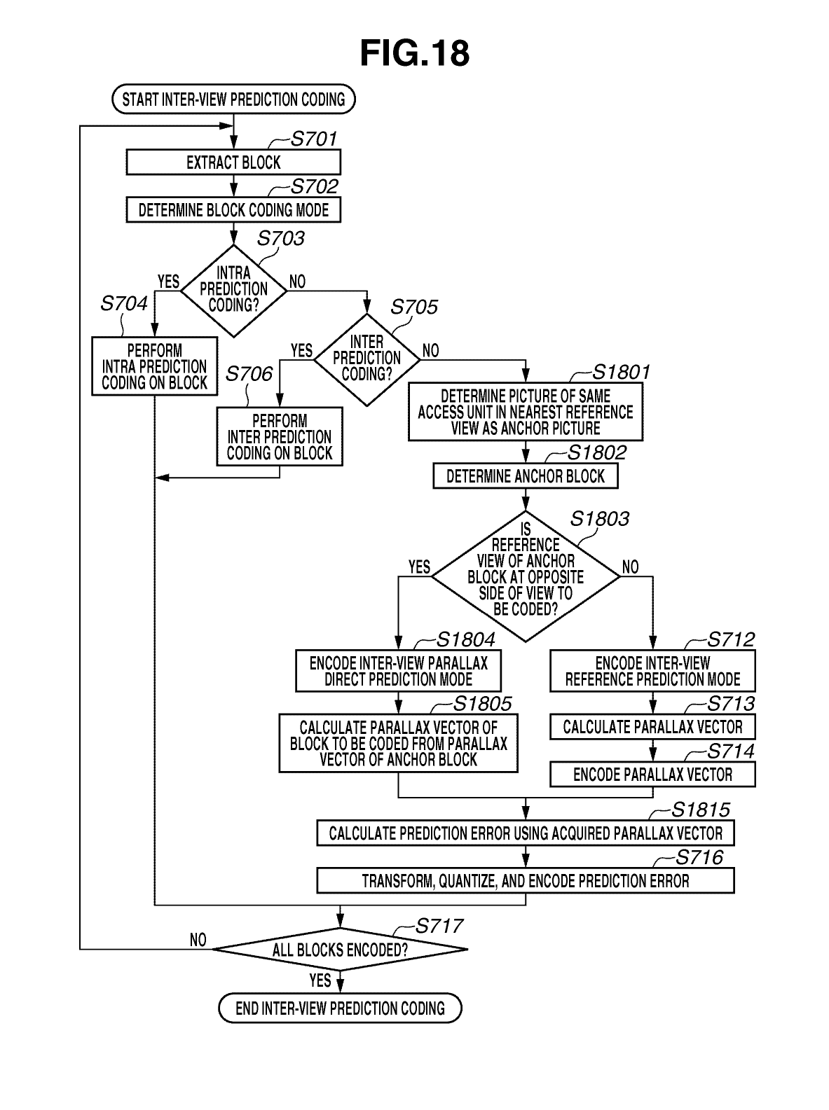

FIG. 18 is a flowchart illustrating the non-base view image coding process performed in the image coding apparatus according to the third exemplary embodiment. The steps illustrated in FIG. 18 performing the same functions as the steps illustrated in FIG. 17 are assigned the same numbers, and description thereof will be omitted. According to the present exemplary embodiment, the base view image coding process is the same as the process of the flowchart illustrated in FIG. 5 according to the first exemplary embodiment.

In step S1801, the image coding apparatus selects the reference view having the nearest reference view number in inter-view prediction. The image coding apparatus then determines the picture of the same access unit in the selected view as the anchor picture. In step S1802, the image coding apparatus sets as the anchor block the block which is at the same position as the block to be coded in the anchor picture determined in step S1801.

In step S1803, the image coding apparatus determines whether the reference view of the anchor block is at the opposite side of the view of the anchor picture when viewed from the view to be coded. If the reference view of the anchor block is at the opposite side (YES in step S1803), the process proceeds to step S1804. If the reference view of the anchor block is not at the opposite side (NO in step S1803), the process proceeds to step S712.

In step S1804, the image coding apparatus sets the coding mode of the block to be coded as the inter-view parallax direct prediction mode, and encodes the block. In step S1805, the image coding apparatus internally-divides the parallax vector of the anchor block and calculates the parallax vector of the block to be coded.

In step S1815, the image coding apparatus calculates, if there is one parallax vector, a prediction value of the pixel value from the reproduced image of the reference picture according to the read parallax vector. If there is a plurality of parallax vectors, the image coding apparatus reads each pixel value from the reproduced image of the reference picture according to the read parallax vector, calculates an average pixel value, and calculates the prediction value. However, the method for calculating the prediction value is not limited to calculating the average value, and a weighted average with respect to the distance between the cameras may be calculated.

As a result, by performing the inter-view parallax direct prediction according to the above-described configuration and the process, the block to be coded is predicted using the parallax vector of the anchor block, and the information on the distance between the cameras becomes common in a sequence. The coded data of the parallax vector thus becomes unnecessary.

According to the present exemplary embodiment, the H.264 coding method is employed. However, it is not limited thereto, and a coding method such as HEVC may also be used. Further, the coding methods of the moving vector and the parallax vector are not limited, and coding may be performed by referring to the coded motion vector and parallax vector.

Furthermore, according to the present exemplary embodiment, the position of the anchor block is at the same position as the block to be coded on the picture. However, it is not limited thereto, and the anchor block may be a block indicating a position which is spatially the same, based on the arrangement of the camera. Moreover, according to the present exemplary embodiment, internal division is performed in the inter-view parallax direct prediction mode with respect to the view at the opposite position of the view including the anchor picture when viewed from the view to be coded. However, it is not limited thereto, and extrapolation may be performed when using a view existing in a direction which is not the opposite direction.

A process for decoding three views according to a fourth exemplary embodiment of the present invention will be described below. However, it is not limited thereto. According to the present exemplary embodiment, the bit stream generated according to the first exemplary embodiment is decoded.

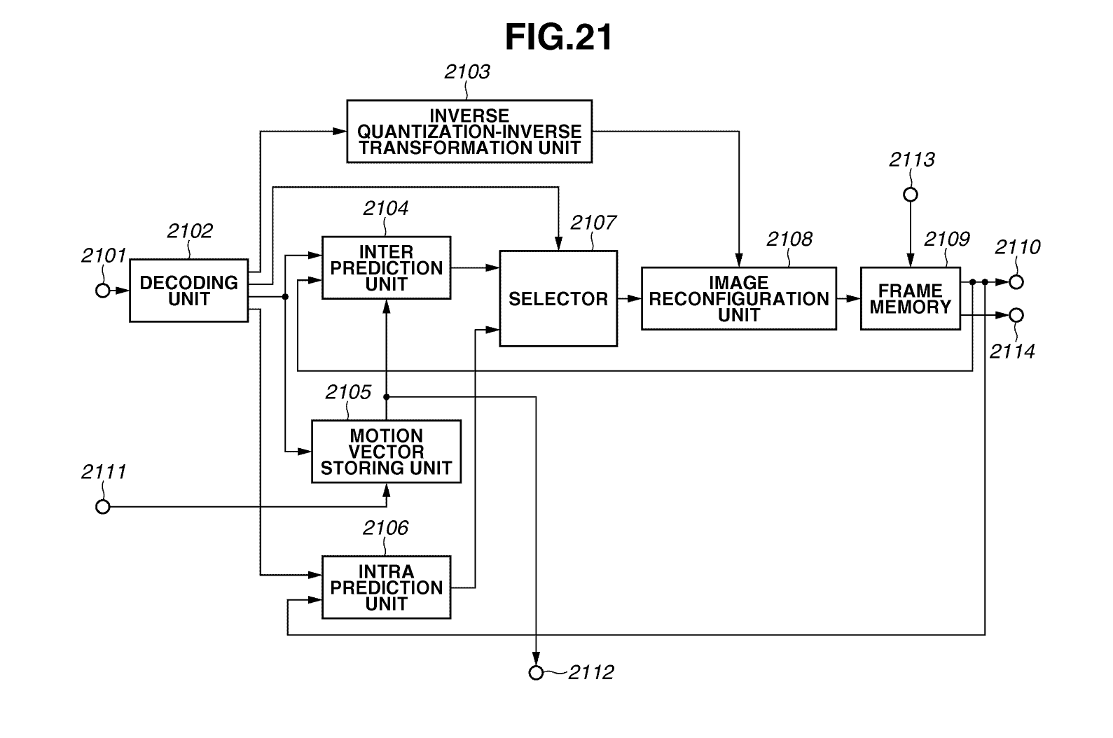

FIG. 21 is a block diagram illustrating in detail the base view decoding unit 2003 in the image decoding system illustrated in FIG. 20.

Referring to FIG. 21, a terminal 2101 inputs, from the MVC decoding unit 2002 in the image decoding system illustrated in FIG. 20, the bit stream of the view on which base view coding has been performed. A decoding unit 2102 decodes the coded data generated in the base view coding unit 104 in the image coding system illustrated in FIG. 1. The decoding unit 2102 decodes the coded data for each block, and reproduces the quantization parameter, the prediction mode, the motion vector, and the quantizing coefficient data. An inverse quantization-inverse transformation unit 2103 similarly operates as the inverse quantization-inverse transformation unit 209 in the base view coding unit 104 illustrated in FIG. 2, and reproduces the prediction error from the quantizing coefficient data.

An inter prediction unit 2104 performs inter prediction from the picture in the same view based on decoded reference information, and calculates the prediction value of the pixel value of the block. The decoded reference information includes the numbers of the view and the picture to be referred to, and the pixel position to be referred to. A motion vector storing unit 2105 stores the decoded motion vector. An intra prediction unit 2106 refers to the reproduced image data of the reproduced image in the same picture from the decoded intra prediction mode and performs intra prediction. The intra prediction unit 2106 then calculates the prediction value of the pixel value of the block.

A selector 2107 switches the input source according to the block coding mode decoded by the decoding unit 2102. If the block coding mode is the inter prediction coding mode, the selector 2107 switches the input source to the inter prediction unit 2104. If the block coding mode is not the inter prediction coding mode, the selector 2107 switches the input source to the intra prediction unit 2106. An image reconfiguration unit 2108 reproduces the image data from the prediction error reproduced by the quantization-inverse transformation unit 2103 and the prediction value of the pixel value input from the selector 2107. A frame memory 2109 stores the reproduced image data of the picture necessary for referring to the picture.

A terminal 2110 outputs the reproduced image data to the outside. A terminal 2111 inputs, from the non-base view coding units 2004 and 2005 illustrated in FIG. 20, the information on the positions of the picture and the block. A terminal 2112 provides the motion vector of the block in the view based on the information input from the terminal 2111. A terminal 2113 inputs the reference information from the non-base view coding units 2004 and 2005 to the frame memory 2109. A terminal 2114 outputs the image data of the decoded image of the view based on the reference information.

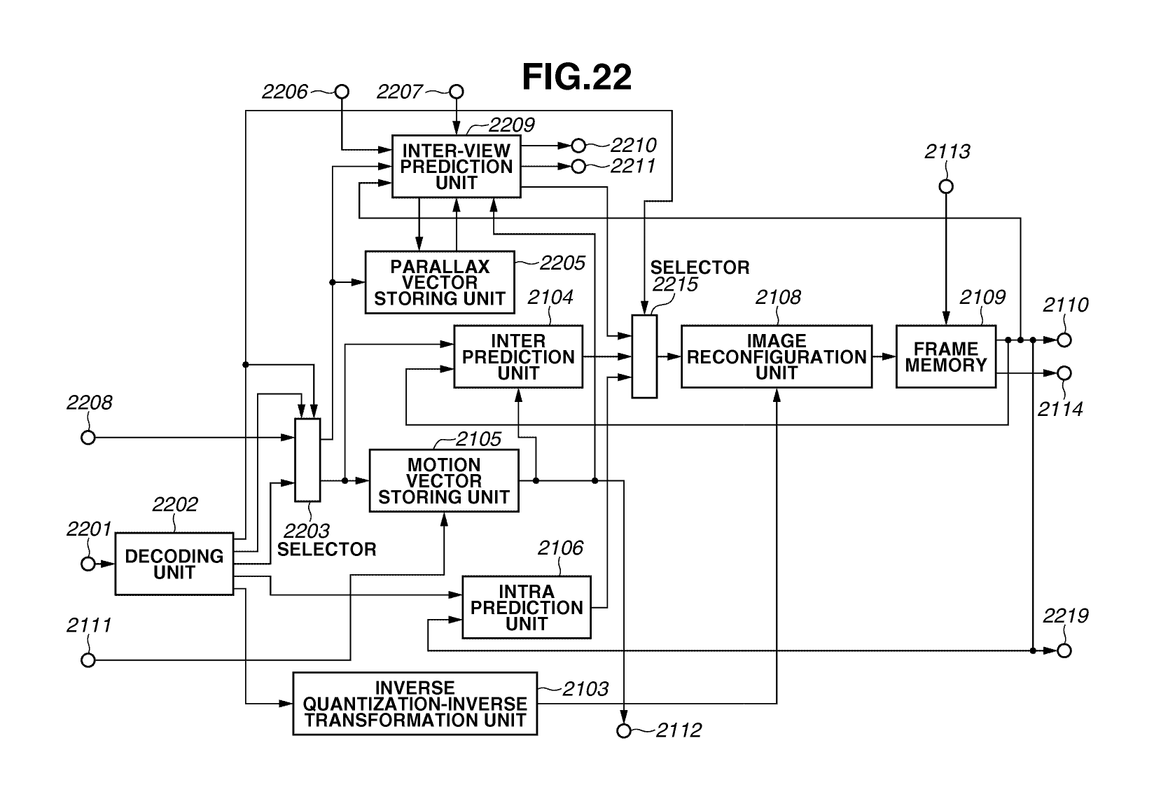

FIG. 22 is a block diagram illustrating in detail the non-base view coding unit 2004 in the image decoding system illustrated in FIG. 20. The non-base view decoding unit 2005 is similarly configured as the non-base view coding unit 2004. The blocks illustrated in FIG. 22 performing the same functions as the blocks in the base view decoding unit 2003 illustrated in FIG. 21 are assigned the same numbers, and description thereof will be omitted.

Referring to FIG. 22, a terminal 2201 inputs, from the outside, e.g., the MVC decoding unit 2002 in the image decoding system illustrated in FIG. 20, the bit stream of the view on which non-base view coding has been performed. A decoding unit 2202 decodes the coded data generated in the non-base view coding unit 105 in the image coding system illustrated in FIG. 1. The decoding unit 2202 decodes the coded data for each block, and reproduces the quantization parameter, the prediction mode, the motion vector, the parallax vector, the inter-view prediction mode, and the quantizing coefficient data. The inter-view prediction mode is reproduced by decoding the direct_view_mv_pred_flag coded data or the direct_view_mv_pred_node coded data described in the first exemplary embodiment.

A terminal 2206 inputs the reproduced image data from the base view decoding unit 2003 or the non-base view decoding unit 2005 in the image decoding system illustrated in FIG. 20. A terminal 2207 inputs the reproduced parallax vector from the non-base view decoding unit 2005. A terminal 2208 inputs the motion vector from the base view decoding unit 2003 or the non-base view decoding unit 2005. A terminal 2210 outputs, to the base view decoding unit 2003 or the non-base view decoding unit 2005, the reference information (i.e., the numbers of the view and the picture to be referred to, and the pixel position to be referred to). A terminal 2211 outputs, to the base view decoding unit 2003 or the non-base view decoding unit 2005, the numbers of the view and the picture in the block to be referred to and the position information for referring to the motion vector of the reference anchor block.

A selector 2203 switches input sources and output destinations of the reference information according to the block coding mode and the inter-view prediction mode decoded by the decoding unit 2202. Table 1 illustrates the relation between the input and the output.

TABLE 1

| | | | Inter-view prediction mode | |
|---|---|---|---|---|
| | | | Inter-view | Inter-view |
| | | Inter prediction | reference | direct |
| | | mode | prediction | prediction |
| Block | Inter | Input: terminal | — | — |
| coding | predic- | 2208 | | |
| mode | tion | Output: inter | | |
| | | prediction unit | | |
| | | 2104, motion | | |
| | | vector storing | | |
| | | unit 2105 | | |
| | Intra | — | — | — |
| | predic- | | | |
| | tion | | | |
| | Inter- | — | Input: | Input: |
| | view | | decoding | terminal |
| | predic- | | unit 2202 | 2208 |
| | tion | | Output: | Output: |
| | | | inter-view | inter-view |
| | | | prediction | prediction |
| | | | unit 2209, | unit 2209, |
| | | | parallax | parallax |
| | | | vector | vector |
| | | | storing | storing |
| | | | unit 2205 | unit 2205 |

Referring to table 1, “—” indicates a non-existing combination, so that there is no output.

A parallax vector storing unit 2205 stores the reproduced parallax vector. An inter-view prediction unit 2209 performs inter-view prediction. More specifically, the inter-view prediction unit 2209 refers to the inter-view prediction mode and the parallax vector which have been decoded and reproduced by the decoding unit 2202, and the parallax vector of the other view and pictures, and performs inter-view prediction. The inter-view prediction unit 2209 then calculates the prediction value of the image data.

A selector 2215 outputs, by switching, the input source according to the block coding mode. If the block coding mode is the inter-view prediction coding mode, the selector 2215 outputs the prediction value generated by the inter-view prediction unit 2209. If the block coding mode is the inter prediction coding mode, the selector 2215 outputs the prediction value generated by the inter prediction unit 2104. If the block coding mode is the intra prediction coding mode, the selector 2215 outputs the prediction value generated by the intra prediction unit 2106.

The operation for decoding the image performed by the image decoding apparatus will be described below. Since the non-base view decoding units 2004 and 2005 perform the same operations with respect to the non-base view decoding operation, the process performed by the non-base view decoding unit 2004 will be described below.

Referring to FIG. 22, the coded data for each block on which base view coding has been performed is input from the terminal 2201 to the decoding unit 2202. At the same time, the coded data of each block on which non-base view coding has been performed is input from the terminal 2201 to the decoding unit 2202.

The decoding unit 2202 divides the input bit stream to the coded data for each block and performs processing. Further, the decoding unit 2202 separates and decodes the quantized coefficient coded data, and calculates the quantized coefficient. The inverse quantization-inverse transformation unit 2103 reproduces the prediction error from the calculated quantized coefficient.

On the other hand, the decoding unit 2202 decodes the block coding mode, and outputs the result to the selectors 2203 and 2215. Further, the decoding unit 2202 decodes the reference information of the picture and the motion vector the block to be decoded refers to, and inputs the result to the inter prediction unit 2104 and the motion vector storing unit 2105.

The inter prediction unit 2104 calculates the prediction value of the pixel value for each block according to the reference picture and the motion vector input from the frame memory 2109. The intra prediction unit 2106 receives the intra prediction mode decoded by the decoding unit 2202, and then calculates the prediction value of the pixel value for each block from the reproduced pixel data in the frame memory 2109, according to the intra prediction mode.

The image reconfiguration unit 2108 receives the prediction values of the pixel values calculated by the inter prediction unit 2104 and the intra prediction unit 2106. Further, the image reconfiguration unit 2108 receives from the inverse quantization-inverse transformation unit 2103 the reproduced prediction error. The image reconfiguration unit 2108 thus generates the reproduced image data from the prediction value and the prediction error, and outputs the result to the frame memory 2109. The frame memory 2109 stores the reproduced image data corresponding to the pictures necessary for reference. The reproduced image data is output from the terminal 2110.

Further, the decoding unit 2202 divides the input bit stream to the coded data for each block and performs processing. The decoding unit 2202 separates and decodes the quantized coefficient coded data, and calculates the quantized coefficient. Furthermore, the decoding unit 2202 decodes the block coding mode, and inputs the result to the selector 2203.

If the coding mode is the inter-view prediction coding mode, the decoding unit 2202 decodes the inter-view prediction mode, and inputs the result to the selector 2203. More specifically, the decoding unit 2202 decodes the inter-view prediction mode by decoding the direct_view_mv_pred_flag coding data. If the resulting value is 0, the mode is the inter-view reference prediction mode, and if the resulting value is 1, the mode is the inter-view direct prediction mode.

If the block coding mode is the intra prediction coding mode, the decoding unit 2202 decodes the intra prediction mode, and inputs the result to the intra prediction unit 2106. If the block coding mode is the inter prediction coding mode, the decoding unit 2202 decodes the information on the reference picture and the motion vector, and inputs the result to the intra prediction unit 2106. If the block coding mode is the inter-view prediction coding mode, the decoding unit 2202 decodes the information on the reference picture and the motion vector, and inputs the result to the selector 2203. The selector 2203 determines the input source and the output destination by referring to the input state and table 1.

If the block coding mode is the intra prediction coding mode, there is no output from the selector 2203. If the block coding mode is the inter prediction coding mode, the selector 2203 inputs to the inter prediction unit 2104 the reference information including the reference picture and the motion vector. If the block coding mode is the inter-view prediction coding mode, the selector 2203 inputs to the inter-view prediction unit 2209 the reference information including the inter-view prediction mode, the reference picture, the reference view, and the parallax vector.

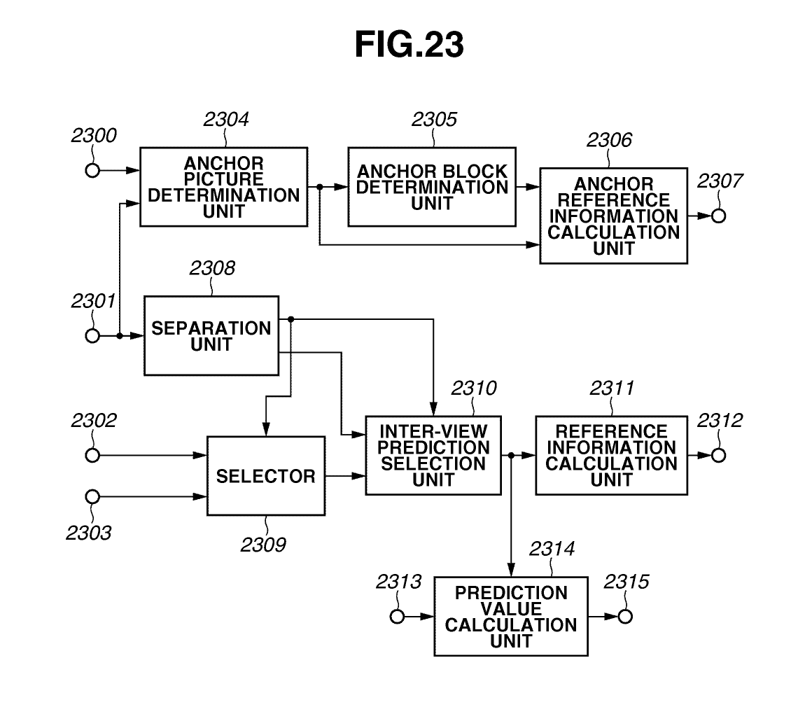

FIG. 23 is a block diagram illustrating in detail the inter-view prediction unit 2209. Referring to FIG. 23, a terminal 2300 is connected to the motion vector storing unit 2105 in the non-base view decoding unit 2004 illustrated in FIG. 22, and inputs the reference information of the picture for calculating the prediction mode and the motion vector. A terminal 2301 is connected to the selector 2203, and inputs the parallax vector and the inter-view prediction mode. A terminal 2302 is connected to the parallax vector storing unit 2205, and inputs the parallax vectors of the other pictures. A terminal 2303 is connected to a terminal 2207 illustrated in FIG. 22, and inputs the parallax vectors of the other views.

An anchor picture determination unit 2304 determines the anchor picture from the pictures of the same view. An anchor block determination unit 2305 determines the position of the anchor block. An anchor reference information calculation unit 2306 generates the reference information indicating the position of the anchor block in the anchor picture. A terminal 2307 is connected to the parallax vector storing unit 2205 illustrated in FIG. 22 and outputs the reference information indicating the anchor block.

A separation unit 2308 separates, into the parallax vector and the inter-view prediction mode, the information input from the terminal 2301. A selector 2309 selects the input from the terminal 2302 or the terminal 2303 according to the inter-view prediction mode separated by the separation unit 2308. An inter-view prediction selection unit 2310 selects and outputs the parallax vector input according to the inter-view prediction mode separated by the separation unit 2308.

A reference information calculation unit 2311 generates the reference information for referring to the image data indicated by the selected parallax vector. A terminal 2312 is connected to the terminal 2210 illustrated in FIG. 22, and outputs the calculated reference information to the outside. A terminal 2313 is connected to the terminal 2206 illustrated in FIG. 22, and inputs the image data based on the reference information calculated by the reference information calculation unit 2311. A prediction value calculation unit 2314 calculates the prediction value based on the parallax vector. A terminal 2315 is connected to the selector 2215 illustrated in FIG. 22, and outputs the prediction value to the outside.

The case where the inter-view prediction mode is the inter-view reference prediction mode will be described below. In such a case, the inter-view prediction unit 2209 receives, from the terminal 2301, the parallax vector and the inter-view prediction mode decoded by the decoding unit 2202. The separation unit 2308 separates the input parallax vector and inter-view prediction mode, and inputs the parallax vector and the inter-view prediction mode to the inter-view prediction selection unit 2310. Since the inter-view prediction mode input to the inter-view prediction selection unit 2310 is the inter-view reference prediction mode, the input parallax vector directly becomes the parallax vector, and is input to the reference information calculation unit 2311 and the prediction value calculation unit 2314.

The reference information calculation unit 2311 calculates, from the input parallax vector, the positions of the view, the picture, and the image data to be referred to, and outputs the result as the reference information from the terminal 2312. The reference information is output from the terminal 2210 in the non-base view decoding unit 2004 illustrated in FIG. 22 to the corresponding base view decoding unit or non-base view decoding unit based on the reference view number.

If the view to be referred to is the view on which base view decoding has been performed, the reference picture number and the parallax vector are input from the terminal 2113 in the base view decoding unit 2003 illustrated in FIG. 21. The corresponding image data is then read and output from the terminal 2114. Further, if the view to be referred to is the view on which non-base view decoding has been performed, the reference picture number and the parallax vector are input from the terminal 2113 of the non-base view decoding unit 2004. The corresponding image data is then read and output from the terminal 2114.

The above-described image data is input via the terminal 2206 in the non-base view decoding unit 2004 illustrated in FIG. 22 to the prediction value calculation unit 2314 via the terminal 2313 in the inter-view prediction unit 2209 illustrated in FIG. 23. The prediction value calculation unit 2314 then calculates the prediction value based on the parallax vector selected by the inter-view prediction selection unit 2310. For example, the prediction value calculation unit 2314 calculates the prediction value corresponding to the parallax vector to decimal places, using filter calculation. The prediction value calculation unit 2314 outputs the calculated prediction value to the selector 2215 in the non-base view coding unit 2004 illustrated in FIG. 22 via the terminal 2315.

The case where the inter-view prediction mode is the inter-view direct prediction mode will be described below. In such a case, the inter-view prediction unit 2209 does not decode the parallax vector, so that only the inter-view prediction mode is input from the terminal 2301 to the separation unit 2308. Further, the anchor picture determination unit 2304 selects as the anchor picture the reference picture having the smallest reference number in the same view in the L1 prediction, input via the terminal 2300. The anchor block determination unit 2305 determines the position of the anchor block from the position information of the block to be decoded, by calculating the position information of the block at the same position as the block to be decoded using the number count of the block. The anchor reference information calculation unit 2306 calculates the reference information from the information on the anchor picture and the anchor block, and outputs the result from the terminal 2307 to the parallax vector storing unit 2205.

The parallax vector of the anchor block is then read from the parallax vector storing unit 2205 based on the reference information of the anchor block, and input to the selector 2309 via the terminal 2303. Since the inter-view prediction mode is the inter-view direct prediction mode, the selector 2309 outputs to the inter-view prediction selection unit 2310 the parallax vector of the anchor block input from the terminal 2303.

Further, since the input inter-view prediction mode is the inter-view direct prediction mode, the parallax vector of the anchor block input to the inter-view prediction selection unit 2310 directly becomes the parallax vector. The inter-view prediction selection unit 2310 thus inputs the parallax vector of the anchor block to the reference information calculation unit 2311 and the prediction value calculation unit 2314. The reference information calculation unit 2311 then calculates the reference information similarly as in the inter-view reference prediction mode, and outputs the result from the terminal 2312. Further, the prediction value calculation unit 2314 calculates the prediction value from the image data input from the terminal 2313 similarly as in the inter-view reference prediction mode, and outputs the result from the terminal 2315.

The output prediction value is input to the selector 2215 illustrated in FIG. 22. The selector 2215 switches the input source and outputs the prediction value according to the block coding mode decoded by the decoding unit 2202. If the block coding mode is the intra prediction coding mode, the selector 2215 inputs the prediction value from the intra prediction unit 2106. If the block coding mode is the inter prediction coding mode, the selector 2215 inputs the prediction value from the inter prediction unit 2104. If the block coding mode is the inter-view prediction coding mode, the selector 2215 inputs the prediction value from the inter prediction unit 2209. The image reconfiguration unit 2108 and the frame memory 2109 then similarly operate as in the base view decoding unit 2003 illustrated in FIG. 21, and output the reproduced image.

The parallax vector in the inter-view direct prediction mode will be further described below with reference to FIG. 8. Referring to FIG. 8, the anchor block 814 in the same view as the block to be coded 813 is determined with respect to the block to be coded 813. The parallax vectors 815 and 816 of the block 814 of the corresponding anchor picture (at time t1) are set as the parallax vectors (819 and 820) of the block to be coded 813.

The parallax vectors and the picture number (t2) are then output from the terminal 2211. The base view decoding unit 2003 outputs from the terminal 2114 the image data of the block 821 in the frame memory 2109 illustrated in FIG. 21 according to the picture number (t2) and the parallax vector 819. The non-base view decoding unit 2005 outputs from the terminal 2114 the image data of the block 822 in the frame memory 2109 illustrated in FIG. 21 according to the picture number (t2) and the parallax vector 820.

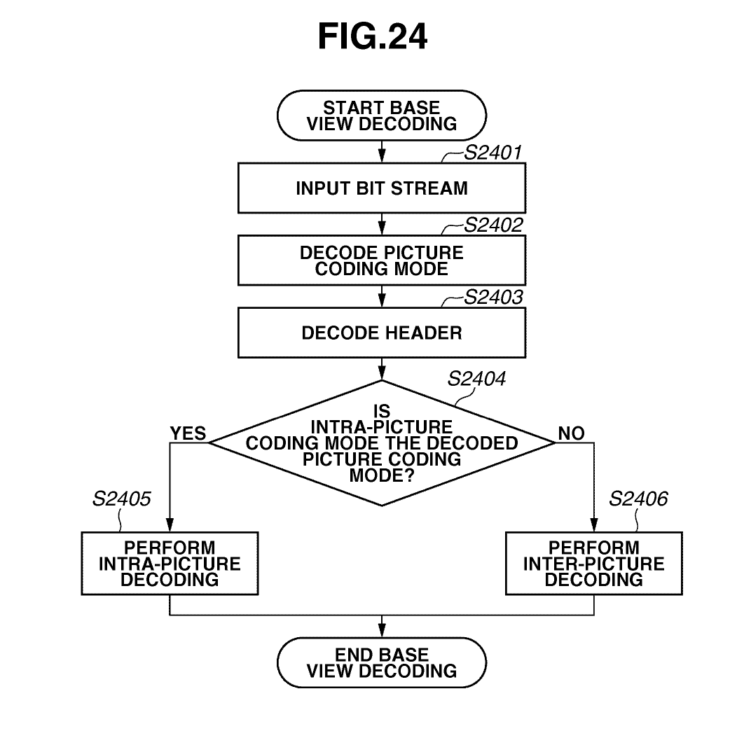

FIG. 24 is a flowchart illustrating the base view image decoding process performed in the image decoding apparatus according to the fourth exemplary embodiment. In step S2401, the image decoding apparatus inputs the bit stream to be decoded corresponding to one picture. In step S2402, the image decoding apparatus decodes from the bit stream the picture coding mode of the picture. The coding mode to be acquired is either the intra prediction coding mode or the inter prediction coding mode. In step S2403, the image decoding apparatus decodes other header data.

In step S2404, the image decoding apparatus determines the picture coding mode decoded in step S2402. If the picture coding mode is the intra-picture coding mode (YES in step S2404), the process proceeds to step S2405. If the picture coding mode is the inter-picture coding mode (NO in step S2404), the process proceeds to step S2406. In step S2405, the image decoding apparatus decodes the picture according to the H.264 intra-picture coding method and generates the reproduced image while maintaining the information necessary for reference. In step S2406, the image decoding apparatus decodes the picture according to the H.264 inter-picture coding method and generates the reproduced image while maintaining the information necessary for reference.

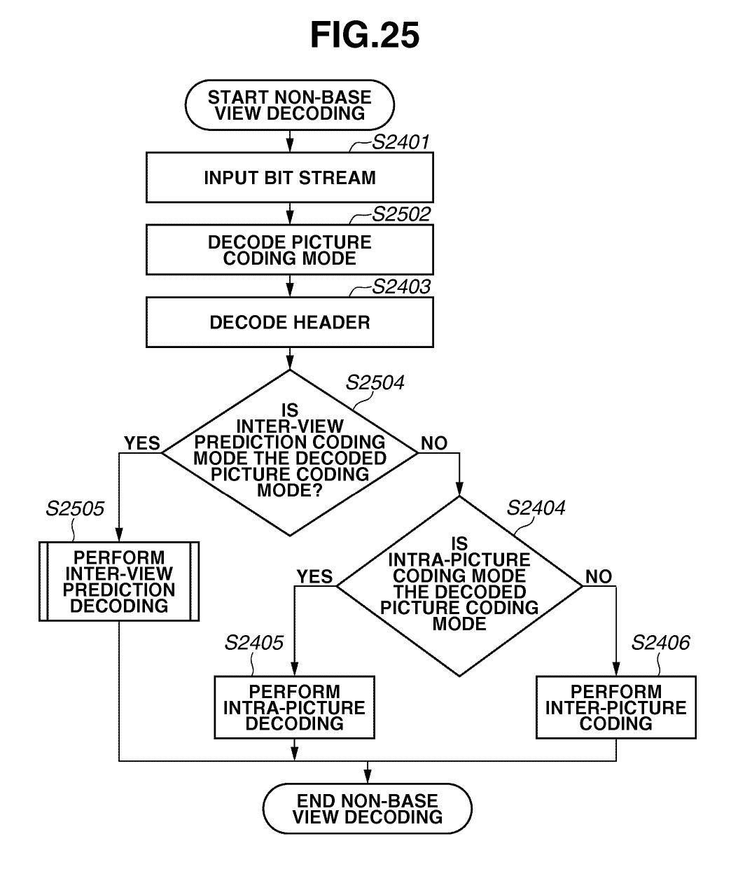

FIG. 25 is a flowchart illustrating the non-base view image decoding process performed in the image decoding apparatus according to the fourth exemplary embodiment. The steps illustrated in FIG. 25 performing the same functions as the steps illustrated in FIG. 24 are assigned the same step numbers, and description thereof will be omitted.

In step S2502, the image decoding apparatus decodes the picture coding mode of the picture from the bit stream, and acquires the intra prediction coding mode, the inter prediction coding mode, or the inter-view prediction coding mode. In step S2504, the image decoding apparatus determines the picture coding mode decoded in step S2502. If the picture coding mode is the inter-view prediction coding mode (YES in step S2504), the process proceeds to step S2505. If the picture coding mode is not the inter-view prediction coding mode (NO in step S2504), the process proceeds to step S2404. In step S2505, the image decoding apparatus decodes the coded data of the picture on which inter-view prediction coding has been performed.

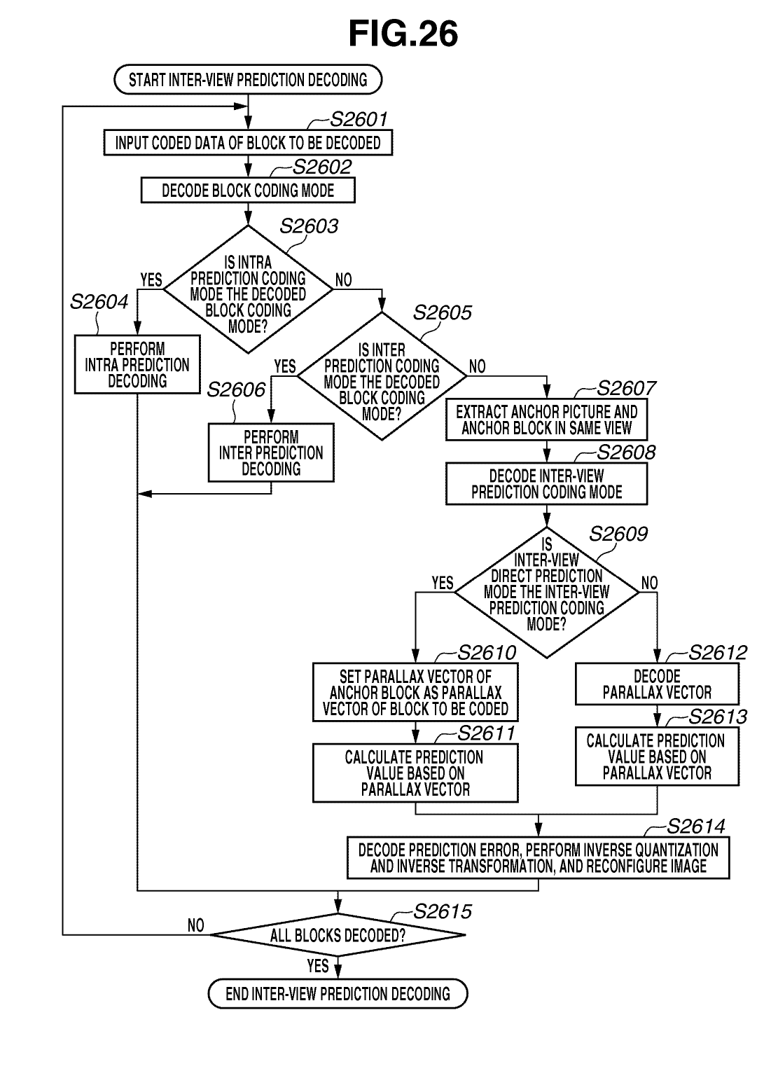

FIG. 26 is a flowchart illustrating in detail the process performed in step S2505 illustrated in FIG. 25. In step S2601, the image decoding apparatus inputs from the coded data of the picture the coded data of the block to be decoded. In step S2602, the image decoding apparatus decodes the block coding mode of the block to be decoded. In step S2603, the image decoding apparatus determines whether the coding mode of the block decoded in step S2602 is the intra prediction coding mode. If the coding mode is the intra prediction coding mode (YES in step S2603), the process proceeds to step S2604. If the coding mode is not the intra prediction coding mode (NO in step S2603), the process proceeds to step S2605.

In step S2604, the image decoding apparatus decodes the coded data of the block according to the procedure of H.264 intra prediction, and generates the reproduced image. In step S2605, the image decoding apparatus determines whether the coding mode of the block decoded in step S2602 is the inter prediction coding mode. If the coding mode is the inter prediction coding mode (YES in step S2605), the process proceeds to step S2606. If the coding mode is not the inter prediction coding mode (NO in step S2605), the process proceeds to step S2607. In step S2606, the image decoding apparatus decodes the coded data of the block according to the procedure of H.264 inter prediction, and generates the reproduced image. The image coding apparatus stores the motion vector for subsequent reference.

In step S2607, the image decoding apparatus extracts the anchor picture in the view that includes the block to be decoded, and extracts the anchor block from the anchor picture. In step S2608, the image decoding apparatus decodes the inter-view prediction coding mode. In step S2609, the image decoding apparatus determines the inter-view prediction coding mode. If the inter-view prediction coding mode is the inter-view direct prediction mode (YES in step S2609), the process proceeds to step S2610. If the inter-view prediction coding mode is not the inter-view direct prediction mode (NO in step S2609), the process proceeds to step S2612.

In step S2610, since the inter-view prediction coding mode is the inter-view direct prediction mode, the image decoding apparatus does not decode the parallax vector, and sets the parallax vector of the anchor block extracted in step S2607 as the parallax vector of the block to be decoded. In step S2611, the image decoding apparatus calculates the prediction value of the pixel by referring to the reproduced image of the other views based on the parallax vector acquired in step S2610.

In step S2612, since the inter-view prediction coding mode is the inter-view reference prediction mode, the image decoding apparatus decodes the coded data of the parallax vector. In step S2613, the image decoding apparatus calculates the prediction value of the pixel by referring to the reproduced image of the other views based on the parallax vector acquired in step S2612.

In step S2614, the image decoding apparatus decodes the prediction error and acquires the quantizing coefficient, performs inverse quantization and inverse transformation on the quantizing coefficient, and reproduces the prediction error. The image decoding apparatus thus reproduces the image data from the reproduced prediction error and the prediction values of the pixel values generated in step S2611 or step S2613.

In step S2615, the image decoding apparatus determines whether all blocks in the picture have been decoded. If the image decoding apparatus has not decoded all blocks (NO in step S2615), the process returns to step S2601, and the image decoding apparatus continues to process the subsequent block to be decoded. If the image decoding apparatus has decoded all blocks (YES in step S2615), the process of decoding the inter-view prediction coded picture ends.

As a result, by performing inter-view direct prediction according to the above-described configuration and process, the block to be decoded is predicted using the parallax vector of the anchor block. The decoded data of the parallax vector data thus becomes unnecessary.

According to the present exemplary embodiment, the H.264 coding method is employed. However, it is not limited thereto, and a coding method such as HEVC may also be used. Further, according to the present exemplary embodiment, whether the coding mode is the intra prediction coding mode, the inter prediction coding mode, or the inter-view prediction mode is determined for each picture, for ease of description. However, it is not limited thereto, and the mode may be switched in a smaller unit, such as a slice or a block.

Furthermore, according to the present exemplary embodiment, the coded data is processed for each block. However, it is not limited thereto, and the coded data may be processed in the input order. Moreover, according to the present exemplary embodiment, the parallax vector with respect to the other views in the same access unit is described as illustrated in FIG. 8. However, it is not limited thereto. For example, other pictures in other views may be referred to by a combination of the parallax vector and the reference picture thereof as illustrated in FIG. 9.

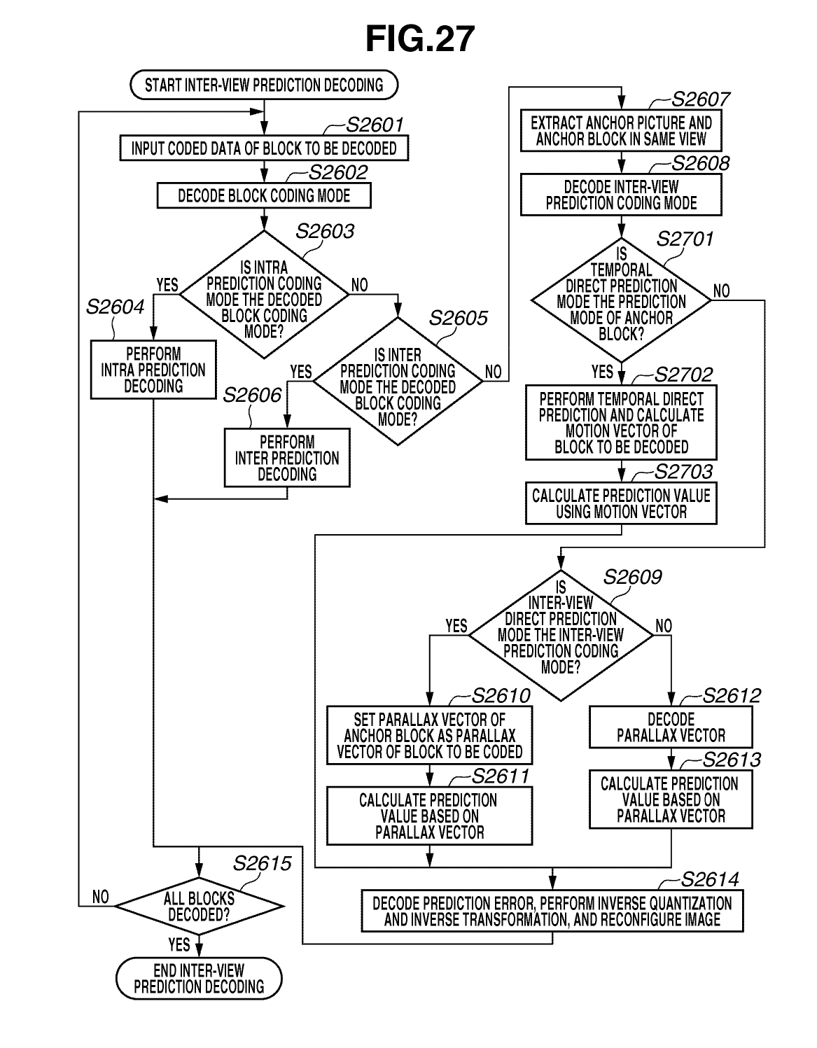

Further, according to the present exemplary embodiment, the inter-view prediction using the parallax vector is performed in step S2609 and the subsequent steps illustrated in FIG. 26. However, it is not limited thereto. For example, if the inter-view prediction mode of the anchor block is the temporal direct prediction mode, the block to be decoded may also be decoded based on temporal direct prediction. FIG. 27 is a flowchart illustrating another inter-view picture decoding process. The steps illustrated in FIG. 27 performing the same functions as the steps illustrated in FIG. 26 are assigned the same numbers, and description thereof will be omitted.

In step S2701, the image decoding apparatus determines whether the prediction mode of the anchor block is the temporal direct prediction mode. If the prediction mode of the anchor block is the temporal direct prediction mode (YES in step S2701), the process proceeds to step S2702. In step S2702, the image decoding apparatus calculates the motion vector of the block to be decoded based on temporal direct prediction. In step S2703, the image decoding apparatus refers to the reproduced image using the calculated motion vector, and calculates the prediction value.

If the prediction mode of the anchor block is not the temporal direct prediction mode (NO in step S2701), the process proceeds to step S2609. In step S2609 and thereafter, the image decoding apparatus performs decoding in the inter-view reference prediction mode or the inter-view direct prediction mode similarly as in the flowchart illustrated in FIG. 26. As a result, temporal direct prediction and inter-view direct prediction can be concurrently used, and the coded bit stream can be decoded at a smaller bit rate.

According to the present exemplary embodiment, when the non-base view decoding process is performed, the motion vector is not read from the view of base view decoding, so that the terminals 2111 and 2112 in the base view decoding unit 2003 may be omitted. Further, according to the present exemplary embodiment, the image decoding apparatus extracts the anchor block in step S2607 illustrated in FIG. 26. However, the image decoding apparatus may extract the anchor block before performing step S2610 when it is determined in step S2609 that the mode is the inter-view direct prediction mode.

The process for decoding three views according to a fifth exemplary embodiment of the present invention will be described below. However, it is not limited thereto. According to the present exemplary embodiment, the configuration of the base view decoding unit 2003 is the same as that according to the fourth exemplary embodiment, and the base view decoding unit 2003 decodes the picture input from the camera 101 without performing inter-view prediction. Further, the configuration of the non-base view decoding unit 2004 is the same as that according to the fourth exemplary embodiment, and will be described below with reference to FIG. 22. The process for decoding the non-base view of the image will be described below.

Referring to FIG. 22, the coded data of each block on which non-base view coding has been performed is input from the terminal 2201 to the decoding unit 2202. The decoding unit 2202 then decodes the quantizing coefficient coded data, and decodes the block coding mode. If the block coding mode is the intra prediction coding mode, the decoding unit 2202 decodes the intra prediction mode, and the intra prediction unit 2106 performs prediction similarly as in the fourth exemplary embodiment. If the block coding mode is the inter prediction coding mode, the decoding unit 2202 decodes the information on the reference picture and the motion vector, and the inter prediction unit 2104 performs prediction based on motion compensation. If the block coding mode is the inter-view prediction coding mode, the decoding unit 2202 decodes the inter-view prediction mode, and inputs the result to the selector 2203.

The decoding unit 2202 decodes the inter-view prediction mode by decoding the direct_view_mv_pred_flag coding data. If the resulting value is 0, the mode is the inter-view reference prediction mode, and if the resulting value is 1, the mode is the inter-view temporal direct prediction mode.

The selector 2203 switches the input sources and output destinations of the reference information according to the input state and by referring to Table 2 described below.

TABLE 2

| | | | Inter-view prediction mode | |
|---|---|---|---|---|
| | | | | Inter-view |
| | | | Inter-view | direct |
| | | Inter prediction | reference | temporal |
| | | mode | prediction | prediction |
| Block | Inter | Input: terminal | — | — |
| coding | predic- | 2208 | | |
| mode | tion | Output: inter | | |
| | | prediction unit | | |
| | | 2104, motion | | |
| | | vector storing | | |
| | | unit 2105 | | |
| | Intra | — | — | — |
| | predic- | | | |
| | tion | | | |
| | Inter- | — | Input: | Input: |
| | view | | decoding | terminal |
| | predic- | | unit 2202 | 2208 |
| | tion | | Output: | Output: |
| | | | inter-view | inter |
| | | | prediction | prediction |
| | | | unit 2209, | unit 2104, |
| | | | parallax | motion |
| | | | vector | vector |
| | | | storing | storing |
| | | | unit 2205 | unit 2105 |

Referring to table 2, “—” indicates a non-existing combination, so that there is no output.

If the block coding mode is the inter-view prediction coding mode, the reference information including the inter-view prediction mode, the reference picture, the reference view, and the parallax vector is input to the inter-view prediction unit 2209. If the inter-view prediction mode is the inter-view reference prediction mode, the process is performed similarly as in the fourth exemplary embodiment.

The case where the inter-view prediction mode is the inter-view temporal direct prediction mode will be described below. In such a case, the motion vector of other view is used, so that the motion vector is not decoded. More specifically, the anchor picture is determined in the same access unit, and the motion vector of the anchor block in the anchor picture is read from the motion vector storing unit 2105. The reference picture number of the anchor picture and the position of the anchor block are input from the terminal 2111 to the motion vector storing unit 2105, and the corresponding motion vector is read from the terminal 2112. The read motion vector is input from the terminal 2208 to the inter prediction unit 2104 via the selector 2203.

The inter prediction unit 2104 refers to the other pictures in the view based on the input motion vector and performs motion compensation, and generates the prediction value. The generated prediction value is input to the image reconfiguration unit 2108 via the selector 2215. The image reconfiguration unit 2108 and the frame memory 2109 then perform the processes similarly as in the base view decoding unit 2003 illustrated in FIG. 21, and outputs the reproduced image.

The motion vector in the inter-view temporal direct prediction mode will be further described below with reference to FIG. 15. Referring to FIG. 15, the anchor block 1501 in the same access unit as the block to be coded 813 is determined with respect to the block to be coded 813. The motion vectors 1504 and 1505 of the block 1501 of the corresponding anchor picture 807 are set as the motion vectors (1508 and 1509) of the block to be coded 813. The motion vector and the view numbers are then output from the terminal 2212 illustrated in FIG. 22. The base view decoding unit 2003 or the non-base view decoding unit 2005 designated by the view number outputs from the terminal 2114 the image data of the blocks 1506 and 1507 in the frame memory 2109 according to the motion vectors 1508 and 1509.

The flowcharts of the processes for decoding the base view image and the non-base view image in the image decoding apparatus according to the fifth exemplary embodiment are the same as the flowcharts illustrated in FIG. 24 and FIG. 25, respectively.

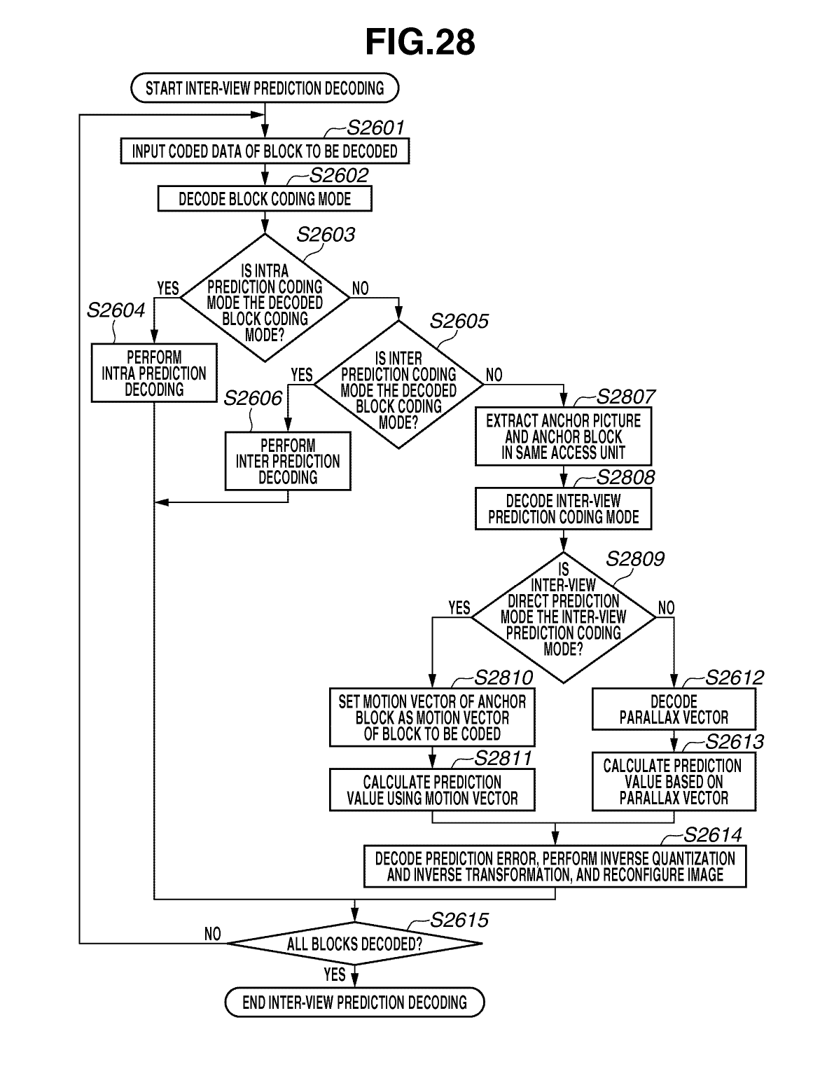

FIG. 28 is a flowchart illustrating the inter-view decoding process performed by the image decoding apparatus according to the fifth exemplary embodiment. The steps illustrated in FIG. 28 performing the same functions as the steps illustrated in FIG. 26 are assigned the same reference number, and description thereof will be omitted. In step S2807, the image decoding apparatus extracts the anchor picture in the access unit that includes the picture to be decoded, and extracts the anchor block from the anchor picture. In step S2808, the image decoding apparatus decodes the inter-view prediction coding mode.

In step S2809, the image decoding apparatus determines the inter-view prediction coding mode. If the inter-view prediction coding mode is the inter-view temporal direct prediction mode (YES in step S2809), the process proceeds to step S2810. If the inter-view prediction coding mode is not the inter-view temporal direct prediction mode (NO in step S2809), the process proceeds to step S2612.

In step S2810, since the inter-view prediction coding mode is the inter-view temporal direct prediction mode, the image decoding apparatus does not decode the motion vector, and sets the motion vector of the anchor block extracted in step S2807 as the motion vector of the block to be decoded. In step S2811, the image decoding apparatus calculates the prediction value of the pixel by referring to the reproduced image of the picture in the same view based on the motion vector acquired in step S2810. In step S2614, the image decoding apparatus reproduces the image data from the prediction error.

As a result, by performing inter-view temporal direct prediction according to the above-described configuration and process, the block to be decoded is predicted using the motion vector of the anchor block. The decoded data of the motion vector thus becomes unnecessary.

According to the present exemplary embodiment, the H.264 coding method is employed. However, it is not limited thereto, and a coding method such as HEVC may also be used. Further, according to the present exemplary embodiment, whether the coding mode is the intra prediction coding mode, the inter prediction coding mode, or the inter-view prediction mode is determined for each picture, for ease of description. However, it is not limited thereto, and the mode may be switched in a smaller unit, such as a slice or a block. Furthermore, according to the present exemplary embodiment, the coded data is processed for each block. However, it is not limited thereto, and the coded data may be processed in the input order. Moreover, according to the present exemplary embodiment, the image decoding apparatus extracts the anchor block in step S2807 illustrated in FIG. 28. However, the image decoding apparatus may extract the anchor block before performing step S2810 when it is determined in step S2809 that the mode is the inter-view temporal direct prediction mode.

The process for decoding three views according to a sixth exemplary embodiment of the present invention will be described below. However, it is not limited thereto. According to the present exemplary embodiment, the configuration of the base view decoding unit 2003 is the same as that according to the fourth exemplary embodiment, and the base view decoding unit 2003 decodes the picture input from the camera 101 without performing inter-view prediction. Further, the configuration of the non-base view decoding unit 2004 is the same as that according to the fourth exemplary embodiment, and will be described below with reference to FIG. 22. The process for decoding the non-base view of the image will be described below.

Referring to FIG. 22, the decoding unit 2202 decodes the block coding mode, and decodes the coded data according to each of the block coding mode, similarly as in the fifth exemplary embodiment. If the block coding mode is the inter-view prediction coding mode, the decoding unit 2202 decodes the inter-view prediction mode, and inputs the result to the selector 2203. The decoding unit 2202 decodes the inter-view prediction mode by decoding the direct_view_mv_pred_flag coding data. If the resulting value is 0, the mode is the inter-view reference prediction mode, and if the resulting value is 1, the mode is the inter-view parallax direct prediction mode.

The selector 2203 switches the input sources and output destinations of the reference information according to the input state and by referring to Table 3 described below.

TABLE 3

| | | | Inter-view prediction mode | |
|---|---|---|---|---|
| | | | | Inter-view |
| | | | Inter-view | parallax |
| | | Inter prediction | reference | direct |
| | | mode | prediction | prediction |
| Block | Inter | Input: terminal | — | — |
| coding | predic- | 2208 | | |
| mode | tion | Output: inter | | |
| | | prediction unit | | |
| | | 2104, motion | | |
| | | vector storing | | |
| | | unit 2105 | | |
| | Intra | — | — | — |
| | predic- | | | |
| | tion | | | |
| | Inter- | — | Input: | Input: |
| | view | | decoding | terminal |
| | predic- | | unit 2202 | 2208 |
| | tion | | Output: | Output: |
| | | | inter-view | inter-view |
| | | | prediction | prediction |
| | | | unit 2209, | unit 2209, |
| | | | parallax | parallax |
| | | | vector | vector |
| | | | storing | storing |
| | | | unit 2205 | unit 2205 |

Referring to table 3, “—” indicates a non-existing combination, so that there is no output.

If the block coding mode is the inter-view prediction coding mode, the reference information including the inter-view prediction mode, the reference picture, the reference view, and the parallax vector is input to the inter-view prediction unit 2209.

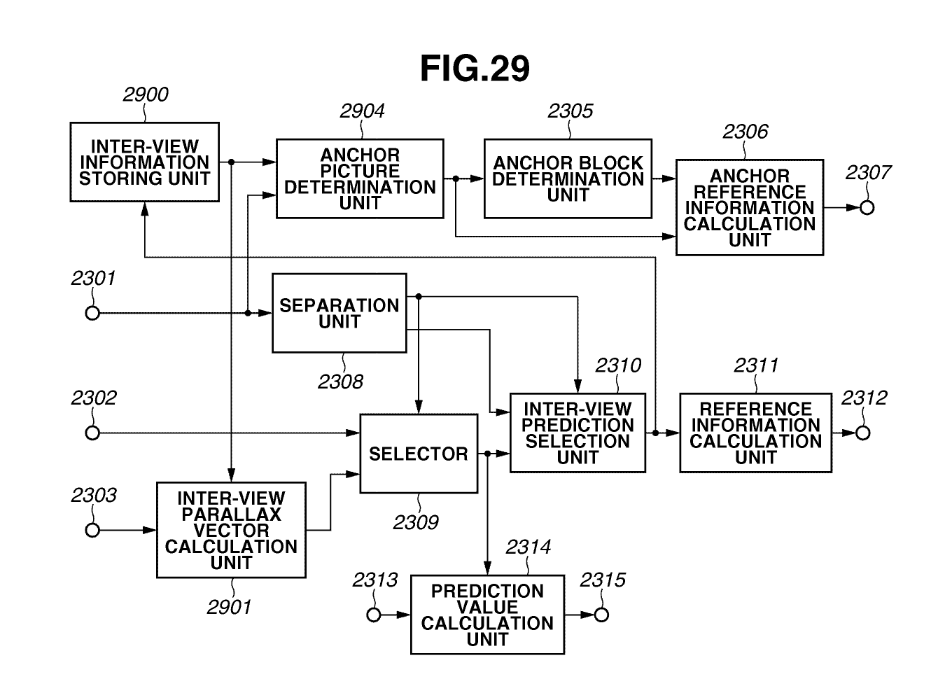

FIG. 29 is a block diagram illustrating in detail the inter-view prediction unit 2209 according to the sixth exemplary embodiment. The blocks illustrated in FIG. 29 performing the same functions as the blocks in the inter-view prediction unit 2209 illustrated in FIG. 23 will be assigned the same reference numbers, and description thereof will be omitted. Referring to FIG. 29, an inter-view information storing unit 2900 stores inter-view information including the positional relation between the other views of the non-view decoding unit 2003, and operates similarly as the inter-view information storing unit 1700 illustrated in FIG. 17. An anchor picture determination unit 2904 operates similarly as the anchor picture determination unit 1704.

An inter-view parallax vector calculation unit 2901 operates similarly as the inter-view parallax vector calculation unit 1701 illustrated in FIG. 17 according to the third exemplary embodiment. If the inter-view prediction mode is the inter-view reference prediction mode, the process is performed similarly as in the fourth exemplary embodiment. Further, the parallax vector of other view is input from the terminal 2303 unlike the fourth exemplary embodiment, so that the terminal 2303 is connected to the terminal 2207 illustrated in FIG. 22. Furthermore, the terminal 2307 corresponds to the terminal 2211 illustrated in FIG. 22, from which the parallax vector is output to the base view decoding unit and the other non-base view decoding unit.

The case where the inter-view prediction mode is the inter-view parallax direct prediction mode will be described below. In such a case, since the parallax vector of the other view is used, the parallax vector is not decoded.

The anchor picture determination unit 2904 in the inter-view prediction unit 2209 determines the anchor picture in the same access unit. The reference information of the anchor block is then generated and output from the terminal 2307 to the base view decoding unit and the other non-base view decoding unit, similarly as in the fourth exemplary embodiment. The terminal 2303 inputs the parallax vector of the anchor block belonging to the anchor picture of the other view acquired as described above.

The inter-view parallax vector calculation unit 2901 then internally-divides the input parallax vector according to the distance between the views stored in the inter-view information storing unit 2900, and outputs the result to the selector 2309. This is similar to the process performed by the inter-view parallax vector calculation unit 1701 illustrated in FIG. 17. Since the separation unit 2308 outputs the inter-view parallax direct prediction mode to the selector 2309, the selector 2309 inputs the parallax vector from the inter-view parallax vector calculation unit 2901, and outputs the parallax vector to the inter-view prediction selection unit 2310. The prediction value is acquired in the subsequent steps similarly as in the fourth exemplary embodiment, and output from the terminal 2315.

The output prediction value is input to the selector 2215, and the selector 2215 outputs, by switching, the input source according to the block coding mode similarly as in the fourth exemplary embodiment. The image reconfiguration unit 2108 and the frame memory 2109 perform the processes similarly as in the base view decoding unit 2003 illustrated in FIG. 21, and output the reproduced image.

The parallax vector in the inter-view parallax direct prediction mode will be further described below with reference to FIG. 19. Referring to FIG. 19, the anchor block 1901 in the same access unit as the block to be coded 813 is determined with respect to the block to be coded 813. The parallax vector 1902 of the block 1901 in the anchor picture 809 is then extracted. The parallax vector 1902 is internally-divided, and the acquired parallax vectors are set as the parallax vectors (1904 and 1905) of the block to be coded. The parallax vectors 1904 and 1905 and the view numbers are then output from the terminal 2211. The base view decoding unit 2003 or the non-base view decoding unit 2005 designated by the view number outputs from the terminal 2114 the image data of the blocks 1906 and 1907 in the frame memory 2109 according to the motion vectors 1904 and 1905.

The flowcharts of the processes for decoding the base view image and the non-base view image in the image decoding apparatus according to the sixth exemplary embodiment are the same as the flowcharts illustrated in FIG. 24 and FIG. 25, respectively.

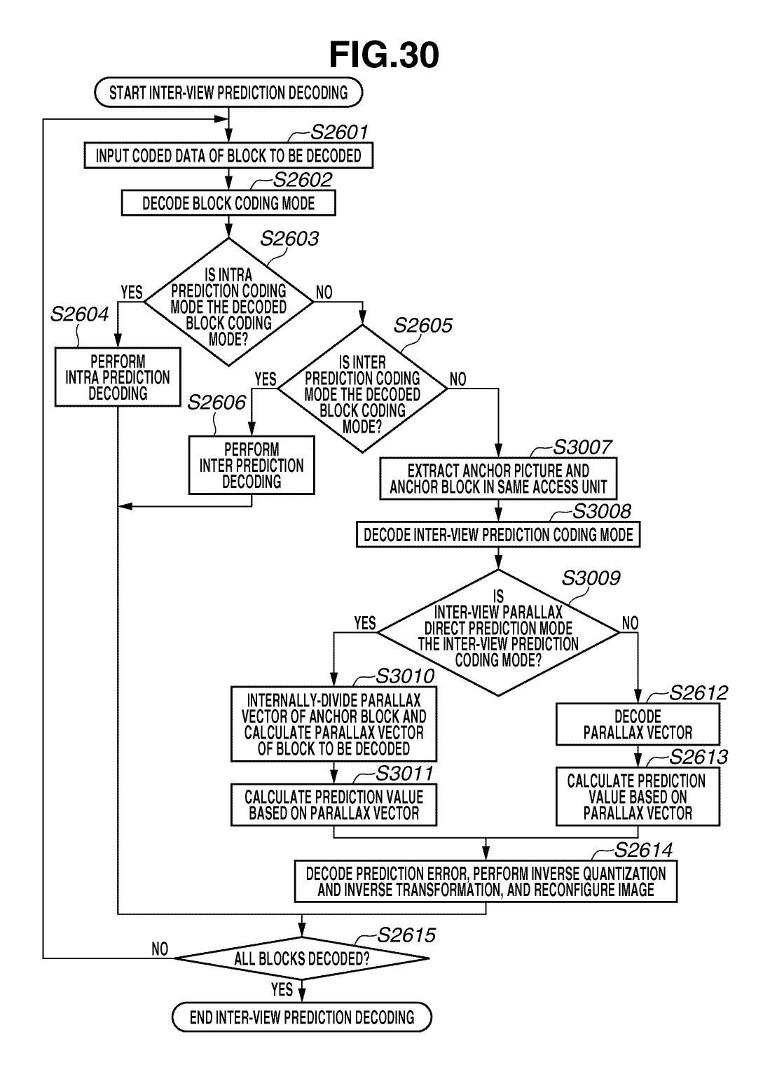

FIG. 30 is a flowchart illustrating the inter-view decoding process performed by the image decoding apparatus according to the sixth exemplary embodiment. The steps illustrated in FIG. 30 performing the same functions as the steps illustrated in FIG. 26 are assigned the same reference number, and description thereof will be omitted.

In step S3007, the image decoding apparatus extracts the anchor picture in the access unit that includes the picture to be decoded, and extracts the anchor block from the anchor picture. In step S3008, the image decoding apparatus decodes the inter-view prediction coding mode. In step S3009, the image decoding apparatus determines the inter-view prediction coding mode. If the inter-view prediction coding mode is the inter-view parallax direct prediction mode (YES in step S3009), the process proceeds to step S3010. If the inter-view prediction coding mode is not the inter-view parallax direct prediction mode (NO in step S3009), the process proceeds to step S2612.

In step S3010, since the inter-view prediction coding mode is the inter-view parallax direct prediction mode, the image decoding apparatus does not decode the parallax vector. The image decoding apparatus instead internally-divides the parallax vector of the anchor block extracted in step S3007, and calculates the parallax vectors of the block to be decoded.

In step S3011, the image decoding apparatus reads the prediction value of the pixel by referring to the reproduced image of the picture in the same access unit based on the two parallax vectors acquired in step S3010. The image decoding apparatus then calculates the prediction value of the pixel value using a method such as averaging described in the third exemplary embodiment. In step S2614, the image decoding apparatus reproduces the image data from the prediction value of the pixel value calculated in step S3011 and the prediction error.

As a result, by performing the inter-view parallax direct prediction according to the above-described configuration and process, the block to be decoded is predicted using the parallax vector of the anchor block. The decoded data of the parallax vector data thus becomes unnecessary.

According to the present exemplary embodiment, the H.264 coding method is employed. However, it is not limited thereto, and a coding method such as HEVC may also be used. Further, according to the present exemplary embodiment, whether the coding mode is the intra prediction coding mode, the inter prediction coding mode, or the inter-view prediction mode is determined for each picture, for ease of description. However, it is not limited thereto, and the mode may be switched in a smaller unit, such as a slice or a block.

Furthermore, according to the present exemplary embodiment, the coded data is processed for each block. However, it is not limited thereto, and the coded data may be processed in the input order. Moreover, according to the present exemplary embodiment, the parallax vector in the anchor block refers to the picture in the same access unit. However, it is not limited thereto. For example, when the anchor block refers to a picture in another access unit, the parallax vector of the block to be decoded also refers to the picture in the same access unit as the anchor block.

Further, according to the present exemplary embodiment, the image decoding apparatus extracts the anchor block in step S3007 illustrated in FIG. 30. However, the image decoding apparatus may extract the anchor block before performing step S3010 when it is determined in step S3009 that the mode is the inter-view parallax direct prediction mode. Furthermore, according to the present exemplary embodiment, the image decoding apparatus performs internal division in the inter-view parallax direct prediction mode with respect to the view existing in a position opposite to the view including the anchor picture as seen from the view to be decoded. However, it is not limited thereto, and extrapolation may be performed when using the view existing in the direction which is not the opposite direction.

According to the above-described exemplary embodiments, each of the processing units illustrated in FIGS. 2, 3, 4, 12, 13, 16, 17, 21, 22, 23, and 29 are configured by hardware. However, the processes performed by each of the processing units may be implemented by a computer program.

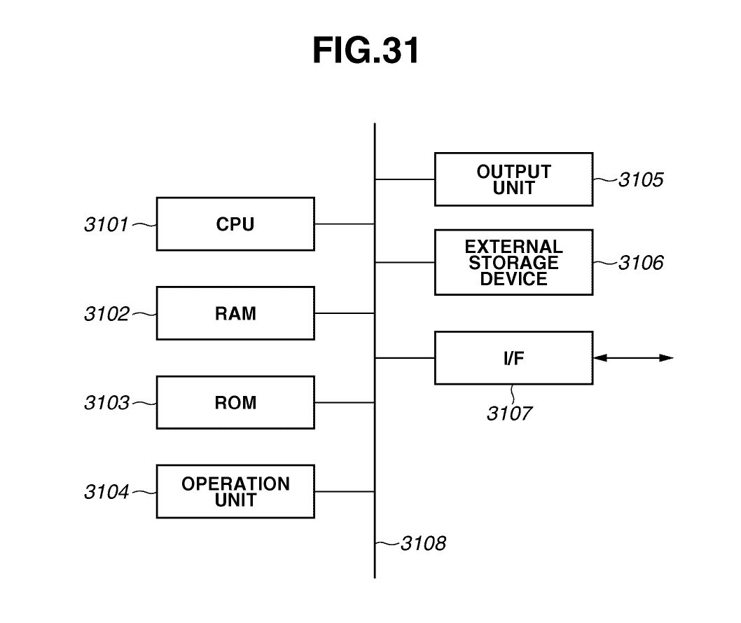

FIG. 31 is a block diagram illustrating a hardware configuration example of a computer applicable to an image processing apparatus according to the above-described exemplary embodiments.

Referring to FIG. 31, a central processing unit (CPU) 3101 controls the computer using the computer program and the data stored in a random access memory (RAM) 3102 and a read-only memory (ROM) 3103. Further, the CPU 3101 executes the above-described processes as an image processing apparatus according to each of the above-described exemplary embodiments. In other words, the CPU 3101 functions as each of the processing units illustrated in FIGS. 2, 3, 4, 12, 13, 16, 17, 21, 22, 23, and 29.

The RAM 3102 includes an area for temporarily storing the computer program and data loaded from an external storage device 3106, and the data acquired from outside via an interface (I/F) 3109. Further, the RAM 3102 includes a work area used by the CPU 3101 for executing the various processes. More specifically, the RAM 3102 may be allocated as the frame memory or may provide as appropriate other types of areas.

The ROM 3103 stores setting data and a boot program of the computer. An operation unit 3104 includes a keyboard and a mouse. The user of the computer operating on the operation unit 3104 can input various instructions to the CPU 3101. An output unit 3105 displays processing results of the CPU 3101. Further, the output unit 3105 may be a hold type display device such as a liquid crystal display, or an impulse type display device such as a field emission type display device.

The external storage device 3106 is a large-volume information storage device such as a hard disk drive. The external storage device 3106 stores an operating system (OS) and the computer programs which causes the CPU 3101 to realize the functions of each unit illustrated in FIGS. 2, 3, 4, 12, 13, 16, 17, 21, 22, 23, and 29. Further, the external storage device 3106 may store the image data to be processed.

The computer programs and the data stored in the external storage device 3106 is loaded as appropriate to the RAM 3102 according to control by the CPU 3101, and are processed by the CPU 3101. The I/F 3107 can be connected to a network such as a local area network (LAN) and the Internet, and other devices such as a projection apparatus and a display apparatus. The computer can thus acquire and transmit various types of information via the I/F 3107. A bus 3108 connects the above-described units.

The above-described operations are mainly controlled by the CPU 3101 controlling the operations described with reference to the above-described flowcharts.

According to the above-described exemplary embodiments, the inter-view direct prediction mode, the inter-view temporal direct mode, the inter-view parallax direct prediction mode, and the inter-view reference prediction mode are separately described. However, the prediction modes may be used as described above, or may be combined and used. For example, a direct_mv_pred_mode code may be set for each block, and a code identifying each mode may be allocated.

An example of the present invention may also be achieved by providing to a system a storage medium in which computer program code realizing the above-described functions is recorded, and the system reading and executing the computer program code. In such a case, the computer program code itself read from the storage medium realizes the functions of the above-described exemplary embodiments, and the storage medium storing the computer program code constitutes an example of the present invention. Further, the OS running on the computer performing a portion or all of the actual processes based on the instruction of the program code may realize the above-described functions.

Furthermore, the computer program code read from the storage medium may be written in a memory included in a function extension card inserted in a computer or a function extension unit connected to the computer. The CPU included in the function extension card or the function extension unit may then perform a portion or all of the actual processes and realize the above-described functions.

In the case where an example of the present invention is applied to the storage medium, the storage medium stores the computer program code corresponding to the above-described flowcharts.

A computer readable storage medium as used within in the context of the present invention is limited to a storage medium which is considered patentable subject matter. A non-limiting list of examples of computer readable storage medium is: RAM; ROM; EEPROM; hard drives; CD-ROM; etc. In the context of the present invention a computer readable storage medium is not a transitory form of signal transmission, such as a propagating electrical or electromagnetic signal.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

1. An image coding method for coding a plurality of pictures corresponding to a plurality of views, the image coding method comprising:
a first determining for determining whether a predetermined block in a predetermined picture in a same view as a target picture to be coded among the plurality of pictures is encoded by referring to a first block in a first picture in a first view different in view from the predetermined picture and same in time as the predetermined picture; and
in a case where it is determined in the first determining that the predetermined block is encoded by referring to the first block in the first picture, encoding a target block to be coded in the target picture to be coded, based on a vector used for encoding the predetermined block.

2. (canceled)

3. The image coding method according to claim 1, wherein, in a case where it is determined in the first determining that the predetermined block is not encoded by referring to the first block in the first picture, the encoding encodes the target block to be coded, by referring to a picture in a different view from the target picture to be coded.

4. The image coding method according to claim 1, further comprising a second determining for determining whether the predetermined block is encoded based on a motion vector in a second block in a second picture different in time from the predetermined picture and same in view as the predetermined picture, the second block being at a position corresponding to the predetermined block,
wherein, in a case where it is determined in the second determining that the predetermined block is encoded based on the motion vector, the encoding encodes the target block to be coded, based on the motion vector.

5-6. (canceled)

7. The image coding method according to claim 1, wherein the predetermined picture is a picture in the same view as the target picture to be coded, and different in time from the target picture to be coded, and
wherein the predetermined picture is a picture closest in time to the target picture to be coded, among candidate pictures to be referred to in a case of L1 prediction of the target picture to be coded.

8-9. (canceled)

10. A computer-readable storage medium storing a program that, when read and executed by a computer, causes the computer to perform the image coding method according to claim 1.

11. An image coding method for coding a plurality of pictures corresponding to a plurality of views, the image coding method comprising:
a first acquiring for acquiring a first prediction error of a case where a target block to be coded in a target picture to be coded among the plurality of pictures is intra-predicted;
a second acquiring for acquiring a second prediction error of a case where the target block to be coded is inter-predicted;
a third acquiring for acquiring a third prediction error of a case where the target block to be coded is inter-view-predicted by referring to a first picture different in view from the target picture to be coded;
a fourth acquiring for acquiring a fourth prediction error of a case where the target block to be coded is encoded based on a vector used for encoding a predetermined block in a predetermined picture in a same view as the target picture to be coded; and
encoding the target block to be coded, based on the first through fourth prediction errors respectively acquired by the first through fourth acquirings.

12. (canceled)

13. A computer-readable storage medium storing a program that, when read and executed by a computer, causes the computer to perform the image coding method according to claim 11.

14. An image decoding method for decoding a bit stream generated by encoding a plurality of pictures corresponding to a plurality of views, the image decoding method comprising:
a first determining for determining whether a predetermined block in a predetermined picture in a same view as a target picture to be decoded among the plurality of pictures is prediction-encoded by referring to a first block in a first picture in a first view different in view from the predetermined picture and same in time as the predetermined picture; and
in a case where it is determined in the first determining that the predetermined block is encoded by referring to the first block in the first picture, decoding a target block to be decoded in the target picture to be decoded, based on a vector used for encoding the predetermined block.

15. (canceled)

16. The image decoding method according to claim 14, wherein, in a case where it is determined in the first determining that the predetermined block is not encoded by referring to the first block in the first picture, the decoding decodes the target block to be decoded, by referring to a picture in a different view from the target picture to be decoded.

17. The image decoding method according to claim 14, further comprising a second determining for determining whether the predetermined block is encoded based on a motion vector in a second block in a second picture different in time from the predetermined picture and same in view as the predetermined picture, the second block being at a position corresponding to the predetermined block,
wherein, in a case where it is determined in the second determining that the predetermined block is encoded based on the motion vector, the decoding decodes the target block to be decoded, based on the motion vector.

18-19. (canceled)

20. The image decoding method according to claim 14, wherein the predetermined picture is a picture in the same view as the target picture to be decoded, and different in time from the target picture to be decoded, and
wherein the predetermined picture is a picture closest in time to the target picture to be decoded, among candidate pictures to be referred to in a case of L1 prediction of the target picture to be decoded.

21-22. (canceled)

23. A computer-readable storage medium storing a program that, when read and executed by a computer, causes the computer to perform the image decoding method according to claim 14.

24. An image coding apparatus for coding a plurality of pictures corresponding to a plurality of views, the image coding apparatus comprising:
a first determination unit configured to determine whether a predetermined block in a predetermined picture in a same view as a target picture to be coded among the plurality of pictures is encoded by referring to a first block in a first picture in a first view different in view from the predetermined picture and same in time as the predetermined picture; and
an encoding unit configured to, in a case where it is determined by the first determination unit that the predetermined block is encoded by referring to the first block in the first picture, encode a target block to be coded in the target picture to be coded, based on a vector used for encoding the predetermined block.

25. An image coding apparatus for coding a plurality of pictures corresponding to a plurality of views, the image coding apparatus comprising:
a first acquisition unit configured to acquire a first prediction error of a case where a target block to be coded in a target picture to be coded among the plurality of pictures is intra-predicted;
a second acquisition unit configured to acquire a second prediction error of a case where the target block to be coded is inter-predicted;
a third acquisition unit configured to acquire a third prediction error of a case where the target block to be coded is inter-view-predicted by referring to a first picture different in view from the target picture to be coded;
a fourth acquisition unit configured to acquire a fourth prediction error of a case where the target block to be coded is encoded based on a vector used for encoding a predetermined block in a predetermined picture in a same view as the target picture to be coded; and
an encoding unit configured to encode the target block to be coded, based on the first through fourth prediction errors respectively acquired by the first through fourth acquisition units.

26. An image decoding apparatus for decoding a bit stream generated by encoding a plurality of pictures corresponding to a plurality of views, the image decoding apparatus comprising:
a first determination unit configured to determine whether a predetermined block in a predetermined picture in a same view as a target picture to be decoded among the plurality of pictures is prediction-encoded by referring to a first block in a first picture in a first view different in view from the predetermined picture and same in time as the predetermined picture; and
a decoding unit configured to, in a case where it is determined by the first determination unit that the predetermined block is encoded by referring to the first block in the first picture, decode a target block to be decoded in the target picture to be decoded, based on a vector used for encoding the predetermined block.

27. An image coding method for coding a picture corresponding to at least one of a plurality of views, the image coding method comprising:
acquiring, in a case where a first block in a first picture in a first view different in view from a target picture to be coded is coded by referring to a second block in a second picture in a second view different from the first view, a first parallax vector which is a parallax vector from the first block to the second block and is used for encoding the first block;
determining whether a direction of the first parallax vector acquired in the acquiring is opposite to a direction from the view of the target picture to be coded to the first view of the first picture; and
encoding, in a case where it is determined in the determining that the direction of the first parallax vector is opposite to the direction from the view of the target picture to be coded to the first view of the first picture, a target block to be coded in the target picture to be coded using a second parallax vector from the target picture to be coded to the first picture, and a third parallax vector from the target picture to be coded to the second picture, the second parallax vector and the third parallax vector being calculated based on the first parallax vector and a distance between the second view and the view of the target picture to be coded.

28. The image coding method according to claim 27, wherein the encoding encodes the target block to be encoded using both of the first picture and the second picture as reference images.

29. The image coding method according to claim 27, wherein the first picture is a picture in a view closest to the view of the target picture to be coded in a same access unit as the target picture to be coded.

30. The image coding method according to claim 27, wherein, in a case where it is determined in the determining that the direction of the first parallax vector is not opposite to the direction from the view of the target picture to be coded to the first view of the first picture, the encoding encodes the target block to be encoded using the first parallax vector.

31. An image decoding method for decoding a bit stream generated by encoding a picture corresponding to at least one of a plurality of views, the image decoding method comprising:
acquiring, in a case where a first block in a first picture in a first view different in view from a target picture to be decoded is prediction-encoded by referring to a second block in a second picture in a second view different from the first view, a first parallax vector which is a parallax vector from the first block to the second block and is used for encoding the first block;
determining whether a direction of the first parallax vector acquired in the acquiring is opposite to a direction from the view of the target picture to be decoded to the first view of the first picture; and
decoding, in a case where it is determined in the determining that the direction of the first parallax vector is opposite to the direction from the view of the target picture to be decoded to the first view of the first picture, a target block to be decoded in the target picture to be decoded using a second parallax vector from the target picture to be decoded to the first picture, and a third parallax vector from the target picture to be decoded to the second picture, the second parallax vector and the third parallax vector being calculated based on the first parallax vector and a distance between the second view and the view of the target picture to be decoded.

32. The image decoding method according to claim 31, wherein the first picture is a picture in a view closest to the view of the target picture to be decoded in a same access unit as the target picture to be decoded.

33. The image decoding method according to claim 31, wherein, in a case where it is determined in the determining that the direction of the first parallax vector is not opposite to the direction from the view of the target picture to be decoded to the first view of the first picture, the decoding decodes the target block to be decoded using the first parallax vector.

34. An image coding apparatus for coding a picture corresponding to at least one of a plurality of views, the image coding apparatus comprising:
an acquiring unit configured to, in a case where a first block in a first picture in a first view different in view from a target picture to be coded is coded by referring to a second block in a second picture in a second view different from the first view, acquire a first parallax vector which is a parallax vector from the first block to the second block and is used for encoding the first block;
a determination unit configured to determine whether a direction of the first parallax vector acquired in the acquiring is opposite to a direction from the view of the target picture to be coded to the first view of the first picture;
an encoding unit configured to, in a case where it is determined in the determining that the direction of the first parallax vector is opposite to the direction from the view of the target picture to be coded to the first view of the first picture, encode a target block to be coded in the target picture to be coded using a second parallax vector from the target picture to be coded to the first picture, and a third parallax vector from the target picture to be coded to the second picture, the second parallax vector and the third parallax vector being calculated based on the first parallax vector and a distance between the second view and the view of the target picture to be coded.

35. An image decoding apparatus for decoding a bit stream generated by encoding a picture corresponding to at least one of a plurality of views, the image decoding apparatus comprising:
an acquiring unit configured to, in a case where a first block in a first picture in a first view different in view from a target picture to be decoded is prediction-encoded by referring to a second block in a second picture in a second view different from the first view, acquire a first parallax vector which is a parallax vector from the first block to the second block and is used for encoding the first block;
a determination unit configured to determine whether a direction of the first parallax vector acquired in the acquiring is opposite to a direction from the view of the target picture to be decoded to the first view of the first picture; and
a decoding unit configured to, in a case where it is determined in the determining that the direction of the first parallax vector is opposite to the direction from the view of the target picture to be decoded to the first view of the first picture, decode a target block to be decoded in the target picture to be decoded using a second parallax vector from the target picture to be decoded to the first picture, and a third parallax vector from the target picture to be decoded to the second picture, the second parallax vector and the third parallax vector being calculated based on the first parallax vector and a distance between the second view and the view of the target picture to be decoded.

36. A computer-readable storage medium storing a program that, when read and executed by a computer, causes the computer to perform the image coding method according to claim 27.

37. A computer-readable storage medium storing a program that, when read and executed by a computer, causes the computer to perform the image decoding method according to claim 31.
